(19) United States
(12) Patent Application Publication
(10) Pub. No.: US 2021/0332283 A1
(43) Pub. Date: Oct. 28, 2021

(54) LIGNIN DERIVATIVES FOR IMPROVED SUSPENSION AND RESERVOIR DRILLING

(71) Applicant: INGEVITY SOUTH CAROLINA, LLC, North Charleston, SC (US)

(72) Inventor: Shadaab S. Maghrabi, Greer, SC (US)

(21) Appl. No.: 17/226,720

(22) Filed: Apr. 9, 2021

Related U.S. Application Data
(60) Provisional application No. 63/009,276, filed on Apr. 13, 2020.

(51) Int. Cl. C09K 8/36; E21B 21/00

(52) U.S. Cl. CPC C09K 8/36; E21B 21/00

(57) ABSTRACT

An oil-based reservoir drill-in fluid (RDF) comprising an oil-based RDF additive that includes a blend, reaction product, or mixture thereof, of (A) one or more hydrophobizing component or agent (e.g., an amine or amide containing compound), and (B) one or more phenolic material or composition comprising phenolic polymers or salts thereof (e.g., lignin, a lignin derivative, or mixture thereof), which may be utilized as an oil-base RDF additive or as a component of an oil-based RDF additive, is described. A method of drilling a reservoir section of a wellbore with the oil-based RDF, the method including the oil-based RDF additive.

### CROSS-REFERENCE TO RELATED APPLICATIONS

The present disclosure claims benefit of and priority to U.S. Provisional Application No. 63/009,276, filed 13 Apr. 2020, titled LIGNIN DERIVATIVES FOR IMPROVED SUSPENSION AND RESERVOIR DRILLING, which is incorporated herein in by reference in its entirety for all purposes.

### INCORPORATION BY REFERENCE

All cited references are hereby incorporated herein by reference in their entirety, including U.S. patent application Ser. No. 16/572,190, filed 16 Sep. 2019, published as U.S. Patent Application Publication No. 2020/0087562 A1, titled LIGNIN DERIVATIVES BASED DRILLING FLUID ADDITIVE.

### TECHNICAL FIELD

The present disclosure relates to an oil-based reservoir drill-in fluid having reduced fluid loss and water in filtrate, while having improved rheological properties. The present disclosure also relates to a method of drilling a reservoir section of a wellbore.

### BACKGROUND

Reservoir drill-in fluid (RDF) is a special fluid designed specifically to drill through the reservoir section of a wellbore. RDF function to (1) drill the reservoir zone successfully, sometimes a long, horizontal drain hole, (2) minimize damage and maximize production of exposed zones, and (3) facilitate the well completion needed. RFD fall into two major categories: water-based mud reservoir drill-in fluid (WBM RDF), and non-aqueous fluid reservoir drill-in fluid (NAF RDF). WBM RDFs has a water continuous phase and contain mostly brine, while NAF RDFs are an invert emulsion of brine in a base oil (such as diesel, mineral oil, etc.) such that the base oil is the continuous phase. The RDF contains easily cleanable solids of appropriate particle size ranges (e.g., calcium carbonate) to bridge the pore throats of the reservoir and to provide the needed density to the RDF, as well as additives for viscosity, suspension, and fluid loss control. These components, along with the drill solids constitute the filter cake formed by the RDF on the porous reservoir formation.

It is imperative that the RDF deliver an efficient and easily cleanable filter cake on the formation wall with minimum fine solids and filtrate invasion into the formation.

An RDF must produce a robust yet thin filter cake, to support the uncased section of the wellbore, often featuring unconsolidated sand or carbonate reservoir or limestone reservoir. However, as RDFs are used in the production zone of oil wells, they must be non-damaging, and the robust, thin filter cake must be produced on the formation wall with minimum fine solids and filtrate invasion into the formation, and be subject to easy removal during clean-up and completion. The invasion of solid fines from the RDF block the pore throats and impair the flow of oil to the wellbore during production. Filtrate invasion can cause emulsion blockages or clay swelling with water filtrates and fine migration deep within the formation, thereby impairing production.

Filter-cake breaker fluid or breaker fluid is utilized to clean the filter cake and remove the near well-bore damage before initiating production. Breaker fluid typically include acids, such as organic acids (e.g., formic acid, acetic acid, lactic acid, citric acid, and the like; see Luai Alhamad et al. A Review of Organic Acids Roles in Acidizing Operations for Carbonate and Sandstone Formations. SPE-199291-MS. 2020, which is incorporated herein by reference in its entirety), precursors to acids (e.g., esters, such as diethylene glycol diformate ester), or strong acids (e.g., HCl) for the dissolution of calcium carbonate in the filter cake and remove the near wellbore damage. In addition, the filter cake breaker fluid can include complexing agents (e.g., ethylene diamine tetra-acetic acid (EDTA) or nitrilotriacetic acid (NTA) can be used to complex the Ca ions in the CaCO₃ thereby cleaning up the filter cake; see Hussain Al-Ibrahim, et al. Chelating agent for uniform filter cake removal in horizontal and multilateral wells: laboratory analysis and formation damage diagnosis. SPE-177982-MS. 2015, which is incorporated herein by reference in its entirety). However, as operators continue to set records for long horizontal sections within productive reservoirs, such as formations that include sandstone and carbonate intercalated with shale, classic WBM RDF with acid-soluble calcium carbonate reveals limitations and shortcomings.

For heavier oil-based RDF having a mud weight of 13-18 ppg, sized calcium carbonate (S.G=2.7) does not provide the needed density for the RDF, so other weighting agents that are preferably acid soluble are required instead of or in addition to the sized calcium carbonate. For example, micronized ilmenite (S.G=4.65) or tri-manganese tetra-oxide (S.G.=4.8) or fine sized hematite (S.G 4.9-5.3) can be added since these are known to be completely or partially acid soluble. Sometimes barite, though not acid soluble can be added along with the CaCO₃ in the RDF, to increase the mud weight due to limitations associated with CaCO₃. However, it is preferred that the majority of the solids added to the RDF beCaCO₃ so that the majority of the filter cake is composed of acid soluble solids. At these high mud weights, suspension of the weighting agent is critical, especially for static conditions in excess of a day, otherwise the fluids may suffer sag, a term of art referring to precipitation of the weighting agent from the fluid. Insufficient suspension can cause drastic density differences in the fluid column across the wellbore, leading to formation fracture and/or kick.

To mitigate sag, rheology modifiers are added. The rheology modifiers, however, tend to excessively increase the rheological properties of fluid for want of improved suspension. Since higher rheological properties leads to higher friction pressure loss (FPL) in the annulus and FPL is inversely proportional to the magnitude of the annulus, a small annulus can cause a very high FPL. The bottom hole pressure during circulation or equivalent circulating density (ECD) is simply the sum of the hydrostatic pressure due to the fluid column and the friction pressure loss in the annulus. In well sections having a narrow drilling window (i.e., the difference between pore pressure and fracture gradient is small, e.g. 1 ppg or less), a fluid with higher rheological properties in a small annulus can have an ECD that exceeds the fracture gradient (when drilling overbalance), thereby leading to the fracture of the formation and the subsequent loss of the fluid to the formation.

One way to mitigate sag associated with low viscosity fluids is to use finely sized weighting agent (e.g. micronized ilmenite (FeTiO₃), very fine sized tri-manganese tetraoxide or even micronized barite). For example, micronized ilmenite, trimanganese tetraoxide, fine sized hematite and micronized barite are commercially available as a weighting agent for drilling applications.

As discussed above, RDFs may be aqueous or non-aqueous, each fluid having certain technical limitations. Calcium carbonate is the most common weighting agent used in RDFs, as the weighting agent part of the resultant filter cakes are readily removed with acid. But, relying exclusively on calcium carbonate as a weighting agent dictates a maximum practical fluid density of nearly 12.5 lb/gal (ppg), and in some cases the density can be up to 14 ppg (see, e.g., BARACARB® Product Data Sheet 25 Mar. 2013; www.halliburton.com/baroid). Furthermore, as applied to use of calcium carbonate in non-aqueous RDF, the addition of the high-volume portion of low-gravity solids (calcium carbonate) necessitates emulsification of greater quantities of water to effect suspension. The resultant fluids of low oil-water ratio (OWR), combined with the high % low-gravity solids (% LGS) content, imparts unacceptably high plastic viscosity (PV) to the fluid.

Akin to completion fluids, higher aqueous RDF density (>12.5 ppg) can be achieved by utilizing various alternative brines, such as calcium bromide, cesium formate and zinc bromide. Though these alternative brines provide the requisite density, they suffer drawbacks of cost and handling hazards, e.g. corrosivity.

Aqueous or water-based RDFs are not optimal in formations comprising swellable clays in their pores, and invert emulsion or oil-based RDFs are one potential solution, though they will also suffer limitations around maximum fluid density, excessive fluid viscosity, excessive cost and/or health and handling hazards.

Therefore, there exists a need to provide RDFs that afford the advantages of invert emulsions (suspension, swellable clay inhibition), while providing high fluid weights, adequate suspension and proper hole-cleaning. As such, there is a need to have an additive for oil-based or NAF RDF that is efficient at controlling fluid loss, provides a thin and easily cleanable filter cake with or without a typical breaker fluid, and that provides improved suspension even at high mud weights without an excessive increase in rheological properties of the fluid.

Fluid-loss additives are added to muds or drilling fluids, or drill-in fluids to minimize filtrate losses and solids fines invasion to the reservoir formation while drilling. Minimizing filtrate losses to the formation helps to maintain wellbore stability, by limiting introduction of filtrate (with or without water), that may destabilize formations. If a high filtrate loss with water (in the filtrate) occurs in reservoir formations, such as sandstone which are intercalated with shales, it may lead to shale instability. For example, swelling of shales, such as smectite clays in the reservoir can block the pore throats and impeding flow of oil and gas during production. By way of further example, dispersion of shale into the reservoir, such as in the case of the kaolinite clay, which can lead to the migration of clay fines through the pore network and block the connectivity of the pores. Furthermore, a high filtrate loss even without water can introduce base oil with emulsifiers to the formation, which can form emulsion blockages when interacting with the formation water during production of oil and gas. High filtrate loss also leads to deeper migration of solid fines present in the filtrate, which blocks pore connectivity and impedes oil and gas flow during production. The deeper the blockage of the pore connectivity in the reservoir (i.e. the deeper the formation damage is from the wall of the annulus), the more difficult is it to clean this damage (due to drilling) during filter cake clean-up or during acid stimulation. As a result, one may have to resort to more expensive workover operations to establish connectivity to the flow of oil and gas from the reservoir into the annulus of the drilled hole. In addition, a high filtrate loss leads to a thick filter cake, which causes operational problems, such as stuck drill pipe. Drilling fluid instability which, if not timely controlled, may lead to major problems like heavy sagging of the oil-based muds, poor hole cleaning, shale sloughing, hole collapse, etc. A low filtrate loss, on the other hand, results in a thin filter cake with minimum filtrate and solid fines invasion into the formation, thereby maintaining pore connectivity relatively intact and/or having minimum formation damage to remove prior to the production phase. In addition, a thin filter case also prevents drill pipe becoming stuck. Thus, fluid-loss control additives perform a very important function when drilling through reservoir and non-reservoir sections. Without being bound by any particular theory, one can consider that filtrate loss additives limit the permeability of the formed filter cake. According to Darcy's law, quickly limiting the permeability of the filter cake, necessarily limits both filtrate invasion and filter cake thickness, since Darcy's law effectively states the proportional relationship between the two.

Traditional fluid-loss additives include black powder-like and white powder-like additives. Commonly used black powder-like additives include (a) oxidized and causticized lignite, (b) amine treated lignite or organophilic lignite, and (c) Gilsonite. Gilsonite and white polymers have been reported as having the potential to cause damage to the formation and are both acid insoluble (see, e.g., Cesar I. Hernandez and Rodolfo Torres. Lessons Learned from Medium and Extended Reach High Pressure Wells in Mexico South. AADE-11-NTCE-12. American Association of Drilling Engineers 2011), thereby making them unfavorable fluid-loss additives for NAF RDF though the authors indicated that this may depend on type of formation drilled and the fluid formulation. Oxidized and/or sulfonated asphalts may also be used as fluid loss additives in oil-based drilling fluids.

Fluid-loss control additives perform a very important function, and there is a need for a fluid-loss additive for reservoir drill-in fluids that delivers improved rheological properties for drilling the reservoir section of a wellbore with an oil-based RDF. In particular, there is a need for superior performing fluid loss additives in reservoir drill-in fluids that provide reduces filtrate and solids fine invasion into the formation and preferably the filtrate loss has no water in the filtrate while the NAF RDF has improved suspension characteristic without adversely affecting the rheological properties of, e.g., the oil-based RDF, and that produces a thin and easily cleanable filter cake. At the same time, there is a need for environmentally friendly and economical fluid-loss control additives in oil-based RDF. Since lignocellulosic biomass is one of the most abundantly available renewable material, a lignin-based fluid-loss control additive for incorporation into reservoir RDF is highly desirable. As such, the present disclosure describes the surprising discovery of NAF RDF or oil-based RDF comprising a novel additive package optimized to deliver low ECD, while producing a thin, robust, non-damaging filter cake. The oil-based RDF of the present disclosure is sag-resistant, at the specified wellbore temperature of interest, and shows exceptionally low filtrate loss at relatively high wellbore temperature and high mud weights.

### SUMMARY

An aspect of the present disclosure provides an oil-based reservoir drill-in fluid (RDF) that comprises an invert emulsion of a hygroscopic liquid, one or more weighting or bridging agent that includes a weighting or bridging agent, an oil-based RDF additive, and at least one of: an oil, diesel oil, mineral oil, synthetic oil (e.g., one or more of internal olefin, poly alpha olefin, and linear paraffin), or a combination thereof. The oil-based RDF further comprises: a blend, reaction product, or a mixture thereof, of: (i) one or more hydrophobizing component or agent, and (ii) one or more phenolic material or composition comprising phenolic polymers or salts thereof.

In any aspect or embodiment described herein, the oil-based RDF further comprises at least one of: (i) one or more emulsifier (e.g., modified tall oil and/or modified fatty amine condensate); (ii) one or more rheological modifier (e.g., at least one of: bentonite clay, a polyamide, a dimer diacid, or combinations thereof); (iii) one or more alkalinity agent (e.g., lime Ca(OH)); (iv) one or more wetting agent (e.g., fatty imidazolines, soya lecithin, or combinations thereof); (v) the weighting or bridging agent is present in an amount of about 2.5 to about 45.0% V/V of the oil-based RDF, wherein one or more of: (a) at least about 50% V/V of the one or more weighting or bridging agent is acid soluble; (b) no more than about 10% V/V of the one or more weighting or bridging agent is acid insoluble; or (c) a combination thereof; or (vii) a combination thereof.

In any aspect or embodiment described herein, for the oil-based RDF of the present disclosure, at least one of: (i) the acid soluble weighting or bridging agent includes or is at least one of calcium carbonate (CaCO₃), manganese oxide (Mn₃O₄), hematite, ilmenite, or a combination thereof; (ii) the acid insoluble weighting or bridging agent includes or is at least one of barite, insoluble components present in trimanganese tetraoxide, insoluble components present in ilmenite, insoluble components present in hematite; or a combination thereof; or (iii) a combination thereof.

In any aspect or embodiment described herein, for the oil-based RDF of the present disclosure, at least one of: (i) the hygroscopic liquid is NaCl brine, NaBr brine, CaBr₂ brine, a formate brine, potassium formate, an alcohol based hygroscopic liquid, lower polyhydric alcohols, glycerol, or polyglycerol; (ii) the oil is diesel; and (iii) the oil-based RDF comprises about 0.25 to about 20.0 pounds per barrel (lbs/bbl) by weight of the oil-based RDF additive; or (iv) a combination thereof.

In any aspect or embodiment described herein, for the oil-based RDF of the present disclosure, at least one of: the phenolic polymers are cross-linked; the hydrophobizing component or agent is an amine or amide containing compound; or a combination thereof.

In any aspect or embodiment described herein, for the oil-based RDF of the present disclosure, at least one of: (i) the phenolic material or composition includes at least one of: lignin, lignin derivative, and salts thereof; (ii) the phenolic material or composition includes at least one of: organosolv lignin, milled wood lignin, cellulotic enzyme lignin, enzymatic mild acidolysis lignin, lignin extracted with ionic liquids, alkali lignin, alkali lignin slurry, sodium salt of lignin, lignin sodium salt slurry, black liquor, Kraft lignosulfonates, Kraft lignin, sulfite lignin, sulfomethylated Kraft lignin, derivatives thereof, and salts thereof; (iii) the hydrophobizing component or agent includes at least one of a fatty amine or amidoamine, a fatty imidazoline, a fatty quaternary amine compound, a fatty imidazolinium compound, and salts thereof; (iv) the hydrophobizing component or agent includes a fatty quaternary amine compound that includes at least one of a diamidoamine quaternary amine compound and an ester of quaternary amine compound; (v) the hydrophobizing component or agent includes at least one of Bis-(isostearic acid amidoethyl)-N-polyethoxy-N-methyl ammonium methosulfate, N, N-bis (tallow amidoethyl) N-polyethoxy N-methylammonium methosulfate, Di (nortallowyloxyethyl) dimethyl Ammonium Chloride, tallow amine, amidoamine, and combinations thereof; or (vi) a combination thereof.

In any aspect or embodiment described herein, for the oil-based RDF of the present disclosure, the lignin derivative includes at least one of: a first sulfonated lignin compound having a sulfonate group located on aliphatic part of the lignin; a second sulfonated lignin compound having a sulfonate group located on aromatic part of the lignin; a third sulfonated lignin compound having a sulfonate group located on aromatic part of the lignin and another sulfonate group located on aliphatic part of the lignin; alkoxylated lignin (e.g., ethoxylated lignin or propoxylated lignin); esterified lignin (e.g., lignin esterified at the hydroxyl group, the carboxyl group, or both); hydroxypropylated lignin; phenolated lignin; alkylated lignin; urethanized lignin; hydroxyalkylated lignin; sulfomethylated lignin; nitrated lignin (e.g., a nitro group added to at least one aromatic group of the lignin); azo coupled lignin (e.g., azo group coupled to at least one aromatic group of the lignin); and a combination thereof.

In any aspect or embodiment described herein, for the oil-based RDF of the present disclosure, the blend, reaction product, or mixture thereof, further comprises formaldehyde.

In any aspect or embodiment described herein, for the oil-based RDF of the present disclosure, the blend, reaction product, or mixture thereof, includes at least one of: (i) the first sulfonated lignin compound that is a sulfonated Kraft lignin, (ii) the second sulfonated lignin compound that is a sulfomethylated Kraft lignin; (iii) the third sulfonated lignin compound that is a Kraft lignin that has been sulfonated and sulfomethylated; or (iv) a combination thereof.

In any aspect or embodiment described herein, for the oil-based RDF of the present disclosure, the blend, reaction product, or mixture thereof, includes at least one of: (i) the first sulfonated lignin compound that has a degree of sulfonation between about 0.1 and about 4.0; (ii) the second sulfonated lignin compound that has a degree of sulfonation between about 0.1 and about 4.0; (iii) the third sulfonated lignin compound that has a degree of sulfonation between about 0.1 and about 4.0; or (iv) a combination thereof.

In any aspect or embodiment described herein, for the oil-based RDF of the present disclosure, for the oil-based RDF of the present disclosure, the fatty amine or amidoamine is prepared by reacting (e.g., reacting under heat) tall oil fatty acid with an amine (such as an ethyleneamine) having at least two (e.g., 2, 3, 4, 5, 6, 7, or more) secondary amine groups.

In any aspect or embodiment described herein, for the oil-based RDF of the present disclosure, the composition comprises at least one of: (i) about 5 to about 75 percent by weight of the hydrophobizing component or agent; (ii) about 25 to about 95 percent by weight of the phenolic material or composition; or (iii) a combination thereof.

In any aspect or embodiment described herein, for the oil-based RDF of the present disclosure, the blend, reaction product, or mixture thereof, further comprises formalin that comprises at least one of: about 30 to about 40% by weight of formaldehyde, and about 10% to about 15% by weight of methanol.

In any aspect or embodiment described herein, for the oil-based RDF of the present disclosure, the composition is a liquid (e.g., a slurry or a polyvinyl alcohol film enclosure or pod comprising a slurry) or a particulate (e.g., spray dried composition, pellets, and/or powder).

Another aspect of the present disclosure provides a method of drilling a reservoir section of a wellbore. The method comprises: circulating an oil-based reservoir drill-in fluid (RDF) when: the drill penetrates the reservoir section, the drill is drilling the reservoir section, or both, wherein the oil-based RDF includes (i) one or more weighting or bridging agent that includes acid soluble weighting or bridging agent and (ii) an oil-based RDF additive comprises a blend, reaction product, or a mixture thereof, of: (i) one or more hydrophobizing component or agent (e.g., about 5 to about 75 percent by weight of the hydrophobizing component or agent), and (ii) one or more phenolic material or composition comprising phenolic polymers or salts thereof (about 25 to about 95 percent by weight of the phenolic material or composition).

In any aspect or embodiment described herein, the oil-based RDF comprises one or more weighting or bridging agent present in an amount of about 2.5 to about 45% V/V of the oil-based RDF, wherein one or more of: (i) at least about 50% of the one or more weighting or bridging agent is acid soluble; (ii) no more than about 10% of the one or more weighting or bridging agent is acid insoluble; or (iii) a combination thereof.

In any aspect or embodiment described herein, for the oil-based RDF, at least one of: (i) the acid soluble weighting or bridging agent includes or is at least one of calcium carbonate (CaCO₃), manganese oxide (Mn₃O₄), ilmenite, or a combination thereof; (ii) the acid insoluble weighting or bridging agent includes or is at least one of barite, insoluble components present in trimanganese tetraoxide, insoluble components present in ilmenite, insoluble components present in hematite; or a combination thereof; or (iii) a combination thereof.

In any aspect or embodiment described herein, the oil-based RDF further comprises at least one of: (i) an invert emulsion of a hygroscopic liquid, and at least one of: an oil, mineral oil, synthetic oil (e.g., one or more of internal olefin, poly alpha olefin, and linear paraffin), or a combination thereof; (ii) one or more emulsifier(s) (e.g., modified tall oil and/or modified fatty amine condensate); (iii) one or more rheological modifier(s) (e.g., at least one of: bentonite clay, a polyamide, a dimer diacid, or combinations thereof); (iv) one or more alkalinity agent(s) (e.g., lime Ca(OH)); (v) one or more wetting agent(s) (e.g., fatty imidazolines, soya lecithin, or combinations thereof); or (vi) a combination thereof.

In any aspect or embodiment described herein, the oil-based RDF includes at least one of: (i) the hygroscopic liquid is NaCl brine, NaBr brine, CaBr₂ brine, a formate brine, potassium formate, an alcohol, lower polyhydric alcohols, glycerol, or polyglycerol; (ii) the oil is diesel; (iii) the oil-based RDF comprises about 0.25 to about 20.0 pounds per barrel (lbs/bbl) by weight of the oil-based RDF additive; or (iv) a combination thereof.

In any aspect or embodiment described herein the method further comprises, after circulating the oil-based RDF, at least one of: (i) removing the oil-based RDF; (ii) removing a filter cake by treating the filter cake with a filter cake breaker fluid through the wellbore; or (iii) a combination thereof.

In any aspect or embodiment described herein, the filter cake breaker fluid comprises at least one of: (i) a brine (e.g., a NaCl brine, NaBr brine, CaCl₂) brine, or CaBr₂ brine); (ii) one or more acid or acid precursor(s) (e.g., citric acid, acetic acid, esters, orthoesters (such as trimethyl orthoacetate, triethyl orthoacetate, tripropyl orthoacetate, triisopropyl orthoacetate, polyorthoacetate, trimethyl orthoformate, triethyl ortho formate, tripropyl orthoformate, triisopropyl orthoformate, polyorthoformates, trimethyl orthopropionate, and/or triethyl orthopropionate), and/or hydrochloric acid (HCl)); (iii) one or more complexing agent(s) (e.g., a complexing agent(s) that chelate ions of the weighting or bridging agent or agents); (iv) one or more solvent(s) (e.g., one or more of ethylene glycol monobutyl ether, propylene glycol monobutyl ether, methanol, isopropyl alcohol, or a combination thereof); (v) one or more surfactant(s) (e.g., a one or more water wetting surfactant(s) to make the filter cake components water wet; e.g., one or more of amine ethoxylate, cocoamido propyl betaine, fatty alcohol ethoxylates, polyoxyethylenesorbitan monolaurate 20, polyoxyethylenesorbitan monolaurate 80, or a combination thereof); (vi) one or more pH control agent(s) (e.g., sodium bicarbonate); (vii) one or more corrosion inhibitor(s) (e.g., one or more of a sulfur containing compound, a quaternary organic ammonium salt, or a combination thereof); (viii) one or more viscosifier(s) (e.g., hydroxyethyl cellulose); or (iv) a combination therefore.

In any aspect or embodiment described herein, the reservoir section has a permeability of about 10 millidarcy (mD) to about 2000 mD.

In any aspect or embodiment described herein, removing the filter cake returns the permeability of the reservoir section to at least about 50% (e.g., at least about 55%, at least about 60%, at least about 65%, at least about 70%, at least about 75%, at least about 80%, at least about 85%, or at least about 90%) of the permeability of the reservoir section prior to drilling.

In any aspect or embodiment described herein, the method further comprises, prior to circulating the oil-based RDF, at least one of: (i) circulating a drilling fluid through the wellbore when drilling (e.g., when drilling the well to depth, and/or not when the drill penetrates the reservoir section, the drill is drilling the reservoir section or both); (ii) removing the drilling fluid from the wellbore; or (iii) a combination thereof.

In any aspect or embodiment described herein, the drilling fluid comprises: an invert emulsion of a hygroscopic liquid (e.g., a brine, such as CaCl₂) brine), an oil (e.g. diesel), mineral oil, and internal olefin.

In any aspect or embodiment described herein, at least one of: the phenolic polymers are cross-linked; and the hydrophobizing component or agent is an amine or amide containing compound.

In any aspect or embodiment described herein, at least one of: (i) the phenolic material or composition includes at least one of: lignin, lignin derivative, and salts thereof; (ii) the phenolic material or composition includes at least one of: organosolv lignin, milled wood lignin, cellulotic enzyme lignin, enzymatic mild acidolysis lignin, lignin extracted with ionic liquids, alkali lignin, alkali lignin slurry, sodium salt of lignin, lignin sodium salt slurry, black liquor, Kraft lignosulfonates, Kraft lignin, sulfite lignin, sulfomethylated Kraft lignin, derivatives thereof, and salts thereof; (iii) the hydrophobizing component or agent includes at least one of a fatty amine or amidoamine, a fatty imidazoline, a fatty quaternary amine compound, a fatty imidazolinium compound, and salts thereof; (iv) the hydrophobizing component or agent includes a fatty quaternary amine compound that includes at least one of a diamidoamine quaternary amine compound and an ester of quaternary amine compound; and (v) the hydrophobizing component or agent includes at least one of Bis-(isostearic acid amidoethyl)-N-polyethoxy-N-methyl ammonium methosulfate, N, N-bis (tallow amidoethyl) N-polyethoxy N-methylammonium methosulfate, Di (nortallowyloxyethyl) dimethyl Ammonium Chloride, tallow amine, amidoamine, and combinations thereof.

In any aspect or embodiment described herein, the lignin derivative includes at least one of: a first sulfonated lignin compound having a sulfonate group located on aliphatic part of the lignin; a second sulfonated lignin compound having a sulfonate group located on aromatic part of the lignin; a third sulfonated lignin compound having a sulfonate group located on aromatic part of the lignin and another sulfonate group located on aliphatic part of the lignin; alkoxylated lignin (e.g., ethoxylated lignin or propoxylated lignin); esterified lignin (e.g., lignin esterified at the hydroxyl group, the carboxyl group, or both); hydroxypropylated lignin; phenolated lignin; alkylated lignin; urethanized lignin; hydroxyalkylated lignin; sulfomethylated lignin; nitrated lignin (e.g., a nitro group added to at least one aromatic group of the lignin); and azo coupled lignin (e.g., azo group coupled to at least one aromatic group of the lignin).

In any aspect or embodiment described herein, the blend, reaction product, or mixture thereof, further comprises formaldehyde.

These and other embodiments are described in detail below.

### BRIEF DESCRIPTION OF THE DRAWINGS

FIG. 1 illustrates the general chemical structures of the various lignin derivatives.

FIG. 2. Effect of pH on the solubility of unmodified and SML under conditions of 10 g/L lignin concentration, 30° C., 2 hours.

FIG. 3 is GPC chromatogram of exemplary fluid-loss additive of the present disclosure.

FIG. 4. Illustration of determination of the flow point/gel point.

### DETAILED DESCRIPTION

The inventors of the present disclosure have surprisingly found that a blend, reaction product, or mixture thereof (e.g., a blend and/or a reaction product), of a phenolic material or composition and a hydrophobizing component or agent provides superior fluid loss control properties when used as an additive in reservoir drill-in fluids (RDFs), such as an oil-based or non-aqueous fluid RDF. The composition and additive described herein surprisingly reduces the fluid loss and water in the filtrate while having improved suspension character in oil-based RDF without adversely affecting the rheological properties of, e.g., the oil-based RDF. The present disclosure outlines the optimization of the fluid system around parameters of fluid rheology, including the fine viscoelastic properties (G′, G″) and flow point/gel point. The present optimized fluids were shown to be sag-resistant by virtue of static age study, and examination of sag factors. Furthermore, exceptionally low filtrate loss values at relatively high wellbore temperature and high mud weights were obtained.

Unless otherwise defined, all technical and scientific terms used herein have the same meaning as commonly understood by one of ordinary skill in the art to which this disclosure belongs. The terminology used in the description is for describing particular embodiments only and is not intended to be limiting of the disclosure.

Where a range of values is provided, it is understood that each intervening value, to the tenth of the unit of the lower limit unless the context clearly dictates otherwise (such as in the case of a group containing a number of carbon atoms in which case each carbon atom number falling within the range is provided), between the upper and lower limit of that range and any other stated or intervening value in that stated range is encompassed within the disclosure. The upper and lower limits of these smaller ranges may independently be included in the smaller ranges is also encompassed within the disclosure, subject to any specifically excluded limit in the stated range. Where the stated range includes one or both of the limits, ranges excluding either both of those included limits are also included in the disclosure.

The following terms are used to describe the present disclosure. In instances where a term is not specifically defined herein, that term is given an art-recognized meaning by those of ordinary skill applying that term in context to its use in describing the present disclosure.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, in certain methods described herein that include more than one step or act, the order of the steps or acts of the method is not necessarily limited to the order in which the steps or acts of the method are recited unless the context indicates otherwise.

The term “effective” is used to describe an amount of a compound, composition or component which, when used within the context of its intended use, effects an intended result. The term effective subsumes all other effective amount or effective concentration terms, which are otherwise described or used in the present application.

The term “reservoir section” (also referred to as “pay-zone” or “producing zone”) are used to describe a subsurface body of rock having sufficient porosity and permeability to store and transmit fluids, such hydrocarbons, including oil and gas.

Oil-Based RDF Composition or Additive

An aspect of the present disclosure provides a composition, which may be utilized in or as an oil-based reservoir drill-in fluid (RDF) additive. The composition or oil-based RDF additive comprises a blend, reaction product, or mixture thereof, of (A) one or more (e.g., 1, 2, 3, 4, 5, 6, 7, or more) hydrophobizing components or agents (e.g., an amine or amid containing compound), and (B) one or more (e.g., 1, 2, 3, 4, 5, 6, 7, or more) phenolic material or composition comprising phenolic polymers or salts thereof (e.g., a cross-linked phenolic polymer, lignin, a lignin derivative, or salts thereof). For example, in any aspect or embodiment described herein, the phenolic polymers are cross-linked. As a further example, in any aspect or embodiment, the hydrophobizing component or agent is an amine or amide containing compound. Thus, in an embodiment, the phenolic polymers are cross-linked, and the hydrophobizing component or agent is an amine or amide containing compound.

In any aspect or embodiment described herein, the phenolic material or composition includes or is at least one of (e.g., 1, 2, 3, 4, 5, 6, 7, 8, or more, each individually selected from): lignin, lignin derivative, or salts thereof. In any aspect or embodiment described herein, the lignin derivative is at least one derivative selected from the group consisting of: (i) a first sulfonated lignin compound having a sulfonate group located on aliphatic part of the lignin, (ii) a second sulfonated lignin compound having a sulfonate group located on aromatic part of the lignin, (iii) a third sulfonated lignin compound having a sulfonate group located on aromatic part of the lignin and another sulfonate group located on aliphatic part of the lignin, (iv) alkoxylated lignin; (v) esterified lignin; (vi) hydroxypropylated lignin; (vii) phenolated lignin; (viii) alkylated lignin; (ix) urethanized lignin; (x) hydroxyalkylated lignin; (xi) sulfomethylated lignin; (xii) nitrated lignin; (xiii) azo coupled lignin, or (xiv) combinations thereof. The (xiv) combinations thereof, includes lignin that have a plurality of derivatizations, e.g. a plurality of derivatizations as described above. For example, in any aspect or embodiment described therein (i) the first sulfonated lignin compound having a sulfonate group located on aliphatic part of the lignin, (ii) the second sulfonated lignin compound having a sulfonate group located on aromatic part of the lignin, and/or (iii) the third sulfonated lignin compound having a sulfonate group located on aromatic part of the lignin and another sulfonate group located on aliphatic part of the lignin, may be further derivitized through alkyoxylation, esterification, hydroxypropylation, phelocation, alkylation, urethanization, hydroxyalkylated, nitration, and/or azo coupling. For example, in any aspect or embodiment described therein, the lignin derivative includes or is alkoxylated sulfonated lignin; esterified sulfonated lignin; hydroxypropylated sulfonated lignin; phenolated sulfonated lignin; alkylated sulfonated lignin; urethanized sulfonated lignin; hydroxyalkylated sulfonated lignin; nitrated sulfonated lignin; azo coupled sulfonated lignin, or combinations thereof.

In any aspect or embodiment described herein, the alkoylated lignin includes or is at least one of: ethoxylated lignin or propoxylated lignin. For example, in any aspect or embodiment described herein, the lignin derivate includes or is at least one of: an ethoxylated compound, such as Reax® 1425E or Reax® 825E, which are ethoxylated sulfonated lignin.

In any aspect or embodiment described herein, the esterified lignin includes or is at least one of a lignin esterified at the hydroxyl group, a lignin esterified at the carboxyl group, and a lignin esterified at the hydroxyl group and at the carboxyl group. In any aspect or embodiment described herein, the nitrated lignin includes or is a lignin in which a nitro group has been added to at least one aromatic group of the lignin. In any aspect or embodiment described herein, the azo couple lignin includes or is a lignin in which an azo group has been added to at least one aromatic group of the lignin.

In any aspect or embodiment describe herein, the blend, reaction product, or mixture thereof, has a pH of less than about 12 (e.g., about 9.5 to about 11.5). For example, in any aspect or embodiment described herein, the method of making the oil-based RDF of the present disclosure includes adjusting the pH of the blend, reaction product, or combination thereof, to a about 9.5 to about 11 (e.g., about 9.5, about 10, about 10.5, about 11). Thus, for example, the pH of the blend, reaction production, or combination thereof, is about 9.5, about 9.75, about 10, about 10.25, about 10.5, about 10.75, about 11, about 11.25, or about 11.5).

In an embodiment, the blend, reaction product, or mixture thereof further comprises formaldehyde. For example, in any aspect or embodiment described herein, the blend, reaction product, or mixture thereof, further comprises a composition having at least one of: about 30 to about 40% by weight of formaldehyde, and about 10 to about 15% by weight of methanol (e.g., formalin).

In any aspect or embodiment described herein, the blend, reaction product, or mixture thereof, includes at least one of: the first sulfonated lignin compound that includes or is a sulfonated Kraft lignin; the second sulfonated lignin compound that includes or is a sulfomethylated Kraft lignin; and the third sulfonated lignin compound that includes or is a Kraft lignin that has been sulfonated and sulfomethylated. For example, in any aspect or embodiment described herein, the blend, reaction product, or mixture thereof, includes the first sulfonated lignin compound that includes or is a sulfonated Kraft lignin. By way of further example, in any aspect or embodiment described herein, the blend, reaction product, or mixture thereof, includes the second sulfonated lignin compound that includes or is a sulfomethylated Kraft lignin. Furthermore, in any aspect or embodiment described herein, the blend, reaction product, or mixture thereof, includes the third sulfonated lignin compound that includes or is a Kraft lignin that has been sulfonated and sulfomethylated.

The lignin derivative can be a lignin derivate produced by Kraft pulping process or a sulfite pulping process. In an embodiment, the lignin derivative is produced by Kraft pulping process. Unlike the sulfite pulping process, Kraft pulping process produces unmodified lignin which can be further processed.

In any aspect or embodiment described herein, the Kraft lignin is sulfonated under controlled conditions to obtain a sulfonated Kraft lignin compound or composition. In any aspect or embodiment described herein, the lignin derivative is a sulfonated Kraft lignin having a specific degree of sulfonation.

In any aspect or embodiment described herein, the lignin derivative is a first sulfonated lignin compound having a sulfonate group located on aliphatic part of the lignin or a composition having a first sulfonated lignin compound. For example, the first sulfonated lignin compound or composition can be a sulfonated Kraft lignin. The sulfonated Kraft lignin may have a specific degree of sulfonation. In any aspect or embodiment described herein, the sulfonated Kraft lignin has a degree of sulfonation between about 0.1 to about 4.0. For example, in any aspect or embodiment described herein, the degree of sulfonation of the first sulfonated lignin described here is selected from about 0.1 to about 4.0, about 0.5 to about 2.5, about 0.5 to about 3.0, about 0.8 to about 3.0, about 1 to about 2.5, or about 1.2 to 2.2.

The degree of sulfonation is a function of the amount of organically bound sulfur present in material and may be determined by any appropriate method known to those skilled in the art. For example, and in no way limiting on the method that may be utilized, sulfonation may be determined by calculating the total sulfur content minus the sum of the amount of sulfur present in the starting composition, and the sulfur present in the free sulfite and sulfate. The percent of free sulfite, the percent of free sulfate, and the percent of total sulfur may be determined by any method known to those skilled in the art.

In any aspect or embodiment described herein, the sulfonated and/or sulfomethylated lignin of the present disclosure has a degree of sulfonation of about 0.1 to about 4.0. For example, in any aspect or embodiment described herein, the degree of sulfonation of the sulfonated lignin, as described herein, can be about 0.1 to about 3.5, about 0.1 to about 3.0, about 0.1 to about 2.5, about 0.1 to about 2.0, about 0.1 to about 1.5, about 0.1 to about 1.0, about 0.5 to about 4.0, about 0.5 to about 3.5, about 0.5 to about 3.0, about 0.5 to about 2.5, about 0.5 to about 2.0, about 0.5 to about 1.5, about 1.0 to about 4.0, about 1.0 to about 3.5, about 1.0 to about 3.0, about 1.0 to about 2.5, about 1.0 to about 2.0, about 1.5 to about 4.0, about 1.5 to about 3.5, about 1.5 to about 3.0, about 1.5 to about 2.5, about 2.0 to about 4.0, about 2.0 to about 3.5, about 2.0 to about 3.0, about 2.5 to about 4.0, about 2.5 to about 3.5, or about 3.0 to about 4.0.

In any aspect or embodiment described herein, the first sulfonated lignin compound composition includes or is at least one compound or composition selected from the group consisting of Polyfon® H, Polyfon® O, Polyfon® T, Polyfon® F, Kraftplex, and combinations thereof. Polyfon® is a registered trademark of Ingevity Inc. and the Polyfon® series compounds are commercially available from Ingevity Inc. The Polyfon® series compounds are prepared from non-sulfonated kraft lignin of “A” slurry (CAS 8068-05-1) by reacting the “A” slurry with sodium bisulfite under pressure, and spray drying the resultant slurry.

In any aspect or embodiment described herein, the Kraft lignin is sulfonated under controlled conditions to obtain a sulfomethylated Kraft lignin compound. For example, in any aspect or embodiment described herein, the lignin derivative can be a sulfomethylated Kraft lignin having a specific degree of sulfonation, as described above.

In any aspect or embodiment described herein, the lignin derivative is a second sulfonated lignin compound having a sulfonate group located on aromatic part of the lignin or a composition comprising the second sulfonated lignin compound. For example, in any aspect or embodiment described herein, the second sulfonated lignin compound can be a sulfomethylated Kraft lignin. Furthermore, the sulfomethylated Kraft lignin may have a specific degree of sulfonation. In any aspect or embodiment described herein, the sulfomethylated Kraft lignin has a degree of sulfonation between about 0.1 to about 4.0, as described above. For example, in any aspect or embodiment described herein, the degree of sulfonation of the sulfonated and/or sulfomethylated lignin described here is selected from about 0.1 to about 4.0, about 0.5 to about 3.5, about 1.5 to about 3.1, and about 1.8 to about 2.9

In any aspect or embodiment described herein, the second sulfonated lignin compound or composition includes or is at least one compound or composition selected from the group consisting of Reax® 907, Reax® 85A, Reax® 81A, Reax® 83A, Reax® 80D, Reax® 88A, Reax® 100 M, Reax® 1425E, Reax® 825E, HyAct®, and combinations thereof. Reax® is a registered trademark of Ingevity Inc. and the Reax® series compounds are commercially available from Ingevity Inc. Other suitable compounds from the Reax® and Polyfon® series can also be used

For example, in any aspect or embodiment described herein, the blend, reaction product, or mixture thereof, includes at least one of: the first sulfonated lignin compound that has a degree of sulfonation between about 0.1 and about 4, and the second sulfonated lignin compound that has a degree of sulfonation between about 0.1 and about 4. In any aspect or embodiment described herein, the blend, reaction product, or mixture thereof, the lignin derivative includes or is the first sulfonated lignin compound that has a degree of sulfonation between about 0.1 and about 4, as described above. In any aspect or embodiment described herein, the blend, reaction product, or mixture thereof, the lignin derivative includes or is the second sulfonated lignin compound that has a degree of sulfonation between about 0.1 and about 4, as described above.

In any aspect or embodiment described herein, the lignin derivative is a third sulfonated lignin compound having a sulfonate group located on aromatic part of the lignin and another sulfonate group located on aliphatic part of the lignin or a composition comprising the third sulfonated lignin compound. The third sulfonated lignin compound may be called a hybrid sulfonated lignin compound. Such compounds are commercially available under tradenames REAX® (e.g., REAX® 88B) and KRAFTSPERSE®. REAX® and KRAFTSPERSE® are a registered trademarks of Ingevity Inc. and the REAX® and KRAFTSPERSE® series compounds are commercially available from Ingevity Inc.

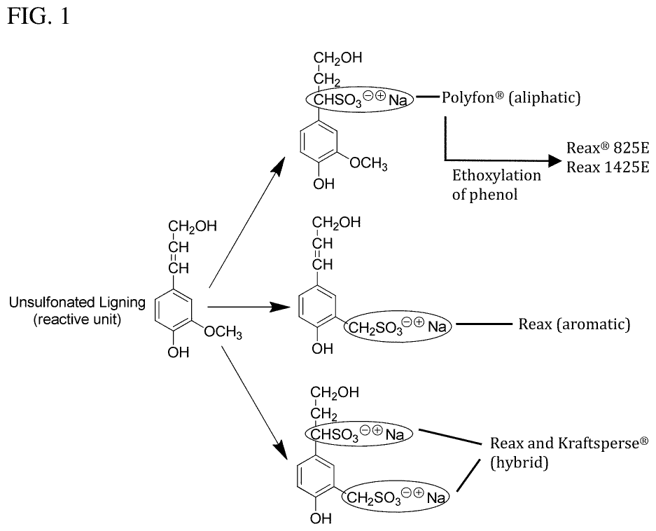

The general chemical structures of the various lignin derivatives are summarized in FIG. 1.

In any aspect or embodiment described herein, the phenolic material or composition includes at least one of: Organosolv lignin, milled wood lignin, cellulotic enzyme lignin, enzymatic mild acidolysis lignin, lignin extracted with ionic liquids, slurry A, slurry C, Indulin AT, Induclin C, black liquor, Kraft lignosulfonates, Kraft lignin, sulfite lignin, sulfomethylated Kraft lignin, derivatives thereof, and salts thereof. In any aspect or embodiment described herein, the phenolic material or composition is at least one of: Organosolv lignin, milled wood lignin, cellulotic enzyme lignin, enzymatic mild acidolysis lignin, lignin extracted with ionic liquids, slurry A, slurry C, Indulin AT, Indulin C, black liquor, Kraft lignosulfonates, Kraft lignin, sulfite lignin, sulfomethylated Kraft lignin, derivatives thereof, and salts thereof. In any aspect or embodiment described herein, the phenolic material or composition is: Organosolv lignin, milled wood lignin, cellulotic enzyme lignin, enzymatic mild acidolysis lignin, lignin extracted with ionic liquids, slurry A, slurry C, Indulin AT, Indulin C, black liquor, Kraft lignosulfonates, Kraft lignin, sulfite lignin, sulfomethylated Kraft lignin, derivatives thereof, and salts thereof.

Thus, in any aspect or embodiment described herein, the phenolic material or composition may include or is lignin or a composition comprising lignin. For example, in any aspect or embodiment described herein, the lignin compound or composition is Kraft lignin. In any aspect or embodiment described herein, the lignin can be at least one of the “A” slurry (CAS 8068-05-1), the “C” slurry (CAS 37203-80-8), or a mixture thereof, that comes from, e.g., paper mills. In any aspect or embodiment described herein, the lignin includes or is Indulin AT. Indulin AT is amine treated “A” slurry that is then spray dried. As used herein, A Slurry, C Slurry, and Black liquor, can be utilized interchangeably with their composition or generic description (e.g., alkali lignin, alkali lignin slurry, sodium salt of lignin, lignin sodium salt slurry, and spent Kraft pulping liquor, respectively), as described herein. Black liquor (CAS 66071-92-9) is spent Kraft pulping liquor, which may comprise about 30-60 wt. % degraded hemicellulose, about 20-50 wt. % degraded lignin, less than or equal to about 5 wt. % sodium hydroxide, less than or equal to about 5 wt. % sodium sulfide, about 5-15 wt. % sodium carbonate, and less than or equal to about 10 wt. % sodium sulfate. Black liquor typically has a solids content of about 39 to about 44 wt. %. Furthermore, the lignin may be a spray dried version of A Slurry, (e.g., Indulin AT), C Slurry (e.g., Indulin C), black liquor, similar compositions, or mixtures thereof.

While organosol lignin and how to prepare the same is known to those skilled in the art, the following description of an exemplary method of preparing the organosol lignin is provide as an exemplary method. Organosol lignin can be prepared by, e.g., pulping a lignocellulosic feedstock, e.g. chipped wood, through contact with an aqueous solvent at temperatures ranging from 140 to 220° C., thereby breaking down lignin through hydrolytic cleavage of alpha aryl-ether links into fragments that are soluble in the solvent. Solvents that can be used include acetone, methanol, ethanol, butanol, ethylene glycol, formic acid, and acetic acid.

While milled wood lignin and how to prepare the same is known to those skilled in the art, the following description of an exemplary method of preparing the milled wood lignin is provide as an exemplary method. For example, milled wood lignin can be prepared by: (1) extracting ball-milled wood with aqueous p-dioxane (about 4%) at room temperature; (2) drying the extracts and then dissolving in acetic acid; (3) precipitating the dissolved extract into water; and (4) drying and then dissolving in ethylene chloride and ethanol; and (5) precipitate the dissolved mixture into diethyl ether.

While cellulolytic enzyme lignin and how to prepare the same is known to those skilled in the art, the following description of an exemplary method of preparing the cellulolytic enzyme lignin is provide as an exemplary method. For example, cellulolytic enzyme lignin can be prepared by: (1) adding ball milled biomass to cellulose and incubating for 3 days; (2) washing with water and extracting twice with aqueous p-dioxane; (3) dissolving the extract in acetic acid; (4) precipitate the dissolved mixture into water; (5) isolate lignin; and (6) wash the isolated lignin twice with water, and suspended in water.

While enzymatic mild acidolysis lignin and how to prepare the same is known to those skilled in the art, the following description of an exemplary method of preparing the enzymatic mild acidolysis lignin is provide as an exemplary method. For example, enzymatic mild acidolysis lignin can be prepared by: (1) treating ball-milled wood with cellulose; (2) shaking in a water bath using citrate buffer (pH 4.5); (3) washing soluble material with acidified deionized water twice; (4) freeze drying the washed soluble materials; (5) treating cellulytic lignin with aqueous p-dioxane; (5) filtering and neutralizing with sodium bicarbonate; (6) add to acidified deionized water and inducate overnight; (7) isolating precipitated lignin; and (8) wash twice with deionized water and freeze-drying the washed lignin.

While lignin extracted with ionic liquids and how to prepare the same is known to those skilled in the art, and may be performed numerous ways, the following reference is provided as a description of exemplary methods of preparing lignin extracted with ionic liquids: Ezinne C. Archinivu, Protic Ionic Liquids for Lignin Extraction-A Lignin Characterization Study. Int J Mol Sci. 2018 February; 19(2): 428, which is incorporated by reference herein in its entirety.

In any aspect or embodiment described herein, the phenolic material or composition includes or is a combination of one or more of: the first sulfonated lignin compound, the second sulfonated lignin compound, the third sulfonated lignin compounds, and a non-sulfonated lignin compound (e.g., lignin, as described herein).

In any aspect or embodiment described herein, the hydrophobizing component or agent may be any suitable amine or amide containing compound. For example, in any aspect or embodiment described herein, the hydrophobizing component or agent includes at least one of a fatty amine, an amidoamine, a fatty imidazoline, a fatty quaternary amine compound, a fatty imidazolinium compound, and salts thereof. In any aspect or embodiment described herein, the hydrophobizing component or agent is at least one of a fatty amine, an amidoamine, a fatty imidazoline, a fatty quaternary amine compound, a fatty imidazolinium compound, and salts thereof. In any aspect or embodiment described herein, the hydrophobizing component or agent is a fatty amine, an amidoamine, a fatty imidazoline, a fatty quaternary amine compound, a fatty imidazolinium compound, and salts thereof. For example, in certain embodiments, the fatty amine compound described above includes a linear or branched fatty chain with more than 8 carbons.

Other suitable amine compounds include primary amines, primary ether amines, tertiary amines, fatty amines, fatty diamines, ether diamines, quaternary amines, fatty quaternary amines, fatty amido amine, fatty amido amine quats, fatty diamidoamines, fatty diamidoamines, quats, fatty imdidazolines, fatty Imidazolinium Quats, fatty ester quaternary amines, fatty amine alkoxylates, dialkyldimethly quats, Benzyl Quats, Alkoxy Alkyl Quats, Trialkyl Monomethyl Quats, and combinations thereof. In any aspect or embodiment described herein, the hydrophobizing component or agent includes or is at least one compound selected from the group consisting of a fatty amine compound, an amidoamine compound, a fatty quaternary amine compound, and combinations thereof.

Fatty amines are made by reacting ammonia with fatty acid to form nitriles, followed by hydrogenation. The alkyl chains in fatty amines can be derived from natural fats and oils such as tallow, soybean oil, tall oil, coconut, canola, and rapeseed. Exemplary fatty amine compounds include hydrogenated tallow amine, palmityl amine, stearyl amine, coco amine, lauryl amine, tallow amine, oleyl amine, and combinations thereof.

In any aspect or embodiment described herein, the hydrophobizing component or agent includes or is at least one a fatty quaternary amine compound selected from the group consisting of a diamidoamine quaternary amine compound and an ester of quaternary amine compound. For example, in any aspect or embodiment described herein, the hydrophobizing component or agent includes or is a fatty quaternary amine compound that includes or is at least one of a diamidoamine quaternary amine compound and an ester of quaternary amine compound.

In any aspect or embodiment described herein, the hydrophobizing component or agent includes or is at least one compound selected from the group consisting of Bis-(isostearic acid amidoethyl)-N-polyethoxy-N-methyl ammonium methosulfate, N, N-bis (tallow amidoethyl) N-polyethoxy N-methylammonium methosulfate, Di (nortallowyloxyethyl) dimethyl Ammonium Chloride, tallow amine, amidoamine, and combinations thereof.

In any aspect or embodiment described herein, the hydrophobizing component or agent includes or is an imidazoline produced from an amidoamine by loss of water molecule. Suitable compounds are described in Tyagi et. al., “Imidazoline and its derivatives: An overview”, Journal of Oleo Science, 56, (5), 211-222 (2007).

In any aspect or embodiment described herein, the hydrophobizing component or agent comprises at least one amidoamine. For example, the amidoamine can be a reaction product of a fatty acid (such as tall oil fatty acid or Soya bean fatty acid or any other source of fatty acid) and an amine. Alternatively, in any aspect or embodiment described herein, the fatty acid source can also be streams from the tall oil distillation process, such as distilled tall oil (which has between 10-30% rosin), C2B, Liqrene D, Liqrene 100, Altapyne 1483. C2B, Liqrene D, Liqrene 100, Altapyne 1483, each of which are tall oil products commercially available from Ingevity, Inc. The acid number of these fatty acid sources can be from 100-200 mgKOH/gm. Amine can be DETA (Diethylene triamine), TETA (Triethylene Tetramine), TEPA (Tetraethylene pentamine), AMINE HST (CAS #68910-05-4) typically having an amine value from 600-850 mgKOH/g, or combinations thereof.

The fatty acid in the reaction product can be from 40-90% w/w and the amine can be from 60-10% w/w. For example, in any aspect or embodiment described herein, the fatty acid may be present in an amount of about 40 to about 90, about 40 to about 80, about 40 to about 70, about 40 to about 60, about 40 to about 50, about 50 to about 90, about 50 to about 80, about 50 to about 70, about 50 to about 60, about 60 to about 90, about 60 to about 80, about 60 to about 70, about 70 to about 90, about 70 to about 80, or about 80 to about 90% w/w. By way of further example, in any aspect or embodiment described herein, the amine is present in an amount of about 10 to about 60, about 10 to about 50, about 10 to about 40, about 10 to about 30, about 10 to about 20, about 20 to about 60, about 20 to about 50, about 20 to about 40, about 20 to about 30, about 30 to about 60, about 30 to about 50, about 30 to about 40, about 40 to about 60, about 40 to about 50, or about 50 to about 60% w/w.

The amine value of the reaction product can be from 1050 mgKOH/g to 15 mgKOH/g. An example of typical process to make such an amido amine is given below. Thus, in any aspect or embodiment described herein, the amine value of the reaction product is about 15 to about 1050, about 15 to about 900, about 15 to about 800, about 15 to about 700, about 15 to about 600, about 15 to about 500, about 15 to about 400, about 15 to about 300, about 15 to about 200, about 15 to about 100, about 100 to about 1050, about 100 to about 900, about 100 to about 800, about 100 to about 700, about 100 to about 600, about 100 to about 500, about 100 to about 400, about 100 to about 300, about 100 to about 200, about 200 to about 1050, about 200 to about 900, about 200 to about 800, about 200 to about 700, about 200 to about 600, about 200 to about 500, about 200 to about 400, about 200 to about 300, about 300 to about 1050, about 300 to about 900, about 300 to about 800, about 300 to about 700, about 300 to about 600, about 300 to about 500, about 300 to about 400, about 400 to about 1050, about 400 to about 900, about 400 to about 800, about 400 to about 700, about 400 to about 600, about 400 to about 500, about 500 to about 1050, about 15005 to about 900, about 500 to about 800, about 500 to about 700, about 500 to about 600, about 600 to about 1050, about 600 to about 900, about 600 to about 800, about 600 to about 700, about 700 to about 1050, about 700 to about 900, about 700 to about 800, about 800 to about 1050, about 800 to about 900, about 900 to about 1050 mgKOH/g.

In any aspect or embodiment described herein, the fatty amine is prepared by reacting tall oil fatty acid with at least one an amine (such as an ethyleneamine) having at least two (e.g., 2, 3, 4, 5, 6, 7, or more) secondary amine groups (e.g., diethylenetriamine (DETA); hydroxyethyldiethylenetriamine (HEDETA); 2-piperazinoethanol; triethylenetetramine (TETA); tetraethylenepentamine (TEPA); pentaethylene hexamine (PEHA), heptaethyleneoctamine (HEOA); hexaethyleneheptamine (HEHA); amine HST; amine DCT; aminoethylpiperazine (AEP); dimethylaminopropylamine (DMAPA); aminoethylethanolamine (AEEA); diethanolamine (DEA); triethanolamine (TEA); monoethanolamine; ethylene diamine; diamino propane; diamino butane; diamino pentane; hexamethylene diamine; diamino alkanes, alkenes or alkynes with up to 12 carbon atoms separating the amino groups) of diethylenetriamine, triethylene tetramine, tetraethylenepentamine, and mixtures thereof. For example, in any aspect or embodiment described herein, the tall oil fatty acid and the at least one amine having at least two secondary amine groups is reacted under heat (e.g., about 150° C. to about 300° C., about 200° C. to about 275° C., or about 258° C.). For example, the fall oil fatty acid and the amine may be heated to a temperature of about 150° C. to about 300° C., about 150° C. to about 275° C., about 150° C. to about 250° C., about 150° C. to about 225° C., about 150° C. to about 200° C., about 150° C. to about 175° C., about 175° C. to about 300° C., about 175° C. to about 275° C., about 175° C. to about 250° C., about 175° C. to about 225° C., about 175° C. to about 200° C., about 200° C. to about 300° C., about 200° C. to about 275° C., about 200° C. to about 250° C., about 200° C. to about 225° C., about 225° C. to about 300° C., about 225° C. to about 275° C., about 225° C. to about 250° C., about 250° C. to about 300° C., about 250° C. to about 275° C., or about 275° C. to about 300° C.

In any aspect or embodiment described herein, the fatty amine or amidoamine, of the fatty imidazoline has an amine value ranging between about 80 to about 300 (e.g., about 210 to about 280) mgKOH/g. For example, the fatty amine has an amine value of about 80 to about 300, about 80 to about 275, about 80 to about 250, about 80 to about 225, about 80 to about 200, about 80 to about 175, about 80 to about 150, about 80 to about 125, about 100 to about 300, about 100 to about 275, about 100 to about 250, about 100 to about 225, about 100 to about 200, about 100 to about 175, about 100 to about 150, about 125 to about 300, about 125 to about 275, about 125 to about 250, about 125 to about 225, about 125 to about 200, about 125 to about 175, about 150 to about 300, about 150 to about 275, about 150 to about 250, about 150 to about 225, about 150 to about 200, about 175 to about 300, about 175 to about 275, about 175 to about 250, about 175 to about 225, about 200 to about 300, about 200 to about 275, about 200 to about 250, about 225 to about 300, about 225 to about 275, or about 250 to about 300 mgKOH/g. Preparation of a non-limiting exemplary amido-amine reaction product, includes: adding about 350 grams (70% w/w) of the C2-B (preheated) with an acid number of 167.2 mg/gm to a five neck round bottom flask (1000 ml). Under stirring at 90 rpm, 150 grams (30% w/w) of Amine HST is added, which gives an exotherm. Once the temperature is stabilized, the reaction mixture is ramped to 200° C. and held at 200° C. for about 2 hours. After about 2 hours, the reaction mixture is cooled to 100° C. The amino-amine reaction product is then transferred to a sample bottle. The amine value of this exemplary C2-B based amido-amine (i.e., the amido-amine reaction product) is determined to be 133.9 mgKOH/g. In any aspect or embodiment described herein, the amidoamine can be further heated, wherein the amidoamine loses a molecule of water to form a ring structured—e.g., imidazoline.

Amine value can be determined by any appropriate method known those skilled in the art. For example, in any aspect or embodiment described herein, amine value can be determined through titration. For example, in any aspect or embodiment described herein, amine value can be determined by titration with 0.5N HCl. An exemplary method that may be used to determine amine value through titration is described below in the Examples.

Acid number can be determined by any appropriate method known those skilled in the art. For example, in any aspect or embodiment described herein, acid number can be determined by titration. For example, in any aspect or embodiment described herein, acid number can be determined by titration with 0.5N KOH. An exemplary method to determine acid number through titration is described below in the Examples.

In any aspect or embodiment described herein, the fatty imidazoline has a imidazoline content of about 35 to about 85% by weight. For example, in any aspect or embodiment described herein, the imidazoline content of the fatty imidazoline is about 35 to about 85% by weight, about 35 to about 75% by weight, about 35 to about 65% by weight, about 35 to about 55% by weight, about 35 to about 45% by weight, about 45 to about 85% by weight, about 45 to about 75% by weight, about 45 to about 65% by weight, about 45 to about 55% by weight, about 55 to about 85% by weight, about 55 to about 75% by weight, about 55 to about 65% by weight, about 65 to about 85% by weight, about 65 to about 75% by weight, about 75 to about 85% by weight of the fatty imidazoline composition. The imidazoline content can be determined by any method appreciated to those skilled in the art. For example, and in no way intended to be limiting, the imidazoline content can be determined by infrared ration. For example, a drop of the fatty imidazoline composition is placed on the Attenuated Total Reflection (ATR) crystal of a Fourier Transform Infrared Spectrometer (such as, a Nicolet 6700 FT-IR) and a spectrum collected. The peak intensities in absorbance mode for the amide (1645-1675 cm-1) and for the imidazoline (1604-1612 cm-1) are ratioed according to the equation:

$$IR = 100 ⨯ \frac{{I}_{imidazoline}}{{I}_{imidazoline} + {I}_{amide}} .$$

The above described exemplary amidoamine is provided as an example of a suitable amidoamine and is not intended to be a limiting example. For example, the fatty acid can be replaced, for example, by tall oil fatty acid (TOFA), and the amine can be substituted by DETA.

In any aspect of embodiment described herein, the composition or oil-based RDF additive comprises about 5 to about 75 weight percent by weight of the hydrophobizing component or agent. In any aspect or embodiment described herein, the composition comprises about 25 to about 95 percent by weight of the phenolic material or composition. For example, in any aspect or embodiment described herein, the composition or oil-based RDF additive comprises at least one of: about 5 to about 75 percent by weight of the hydrophobizing component or agent, and about 25 to about 95 percent by weight of the phenolic material or composition.

In any aspect or embodiment described herein, the composition or oil-based RDF additive comprises at least one of: about 25 to about 45 percent by weight of the hydrophobizing component or agent, and about 55 to about 75 percent by weight of the phenolic material or composition. For example, in any aspect or embodiment described herein, the composition or oil-based RDF additive comprises: (1) at least one of about 38 percent by weight of the hydrophobizing component or agent, and about 62 percent by weight of the phenolic material or composition; or (2) at least one of about 28 percent by weight of the hydrophobizing component or agent, and about 72 percent by weight of the phenolic material or composition.

In any aspect or embodiment described herein, the composition or oil-based RDF additive (e.g., the blend, reaction product, or mixture thereof) further comprises formaldehyde. For example, the oil-based RDF additive or composition further comprises formalin.

In any aspect or embodiment described herein, the composition or oil-based RDF additive is a slurry, a dissolvable enclosure or pod (e.g., polyvinyl alcohol film enclosure or pod) comprising the liquid or slurry, a spray dried composition, pellets, a powder, or a mixture thereof.

Oil-Based RDF

Another aspect of the present disclosure is an oil-based RDF that comprises the oil-based RDF fluid-loss additive or composition described herein. For example, in any aspect or embodiment described herein, the oil-based RDF of the present disclosure comprises a blend and/or a reaction product of one or more phenolic material or composition that comprises phenolic polymers or salts thereof (such as a cross-linked phenolic polymer, lignin, a lignin derivative, or mixtures thereof), and one or more hydrophobizing component or agent (such as an amine or amide containing compound), as described herein.

In any aspect or embodiment described herein, the oil-based RDF comprises an invert emulsion of a hygroscopic liquid, an oil-based RDF additive, one or more weighting or bridging agent that includes a weighting or bridging agent, and at least one of: an oil (e.g. diesel oil or low sulfur diesel oil), mineral oil, synthetic oil (e.g., one or more of internal olefin, alpha olefin, poly alpha olefin, and linear paraffin), or a combination thereof. In any aspect or embodiment described herein, the oil-based RDF comprises about 0.25 to about 20.00 pounds per barrel (lbs/bbl) by weight of the oil-based RDF additive. For example, in any aspect or embodiment described herein, the oil-based RDF fluid-loss additive or composition is present in an amount of about 0.25 to about 20.00, about 0.25 to about 17.50, about 0.25 to about 15.00, about 0.25 to about 12.50, about 0.25 to about 10.00, about 0.25 to about 7.50, about 0.25 to about 5.00, about 2.50 to about 20.00, about 2.50 to about 17.50, about 2.50 to about 15.00, about 2.50 to about 12.50, about 2.50 to about 10.00, about 2.50 to about 7.50, about 5.00 to about 20.00, about 5.00 to about 17.50, about 5.00 to about 15.00, about 5.00 to about 12.50, about 5.00 to about 10.00, about 7.50 to about 20.00, about 7.50 to about 17.50, about 7.50 to about 15.00, about 7.50 to about 12.50, about 10.00 to about 20.00, about 10.00 to about 17.50, about 10.00 to about 15.00, about 12.50 to about 20.00, about 12.50 to about 17.50, about 15.00 to about 20.00 lbs/bbl by weight of the oil-based RDF additive.

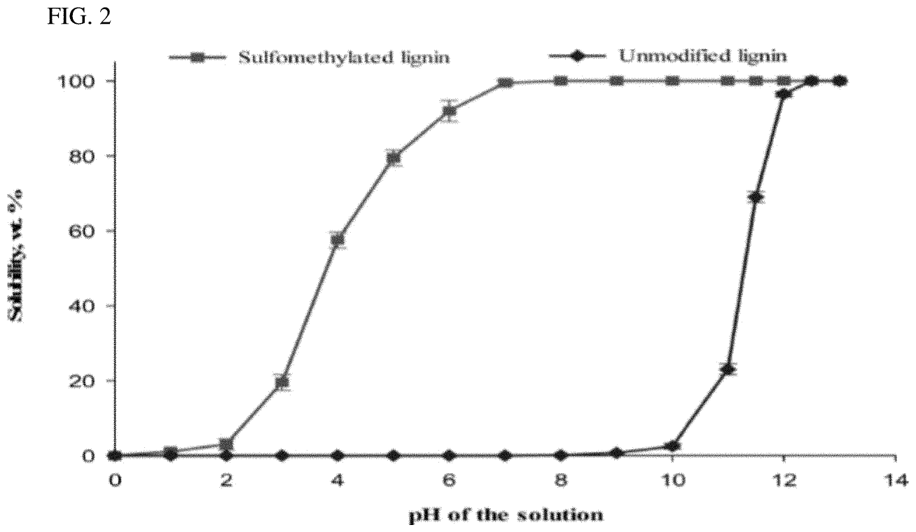

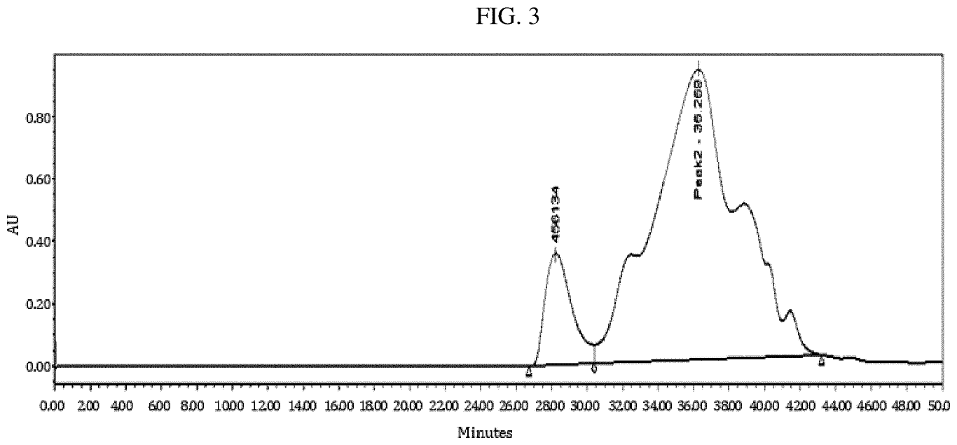

In any aspect or embodiment described herein, the oil-based RDF comprises either oil or mineral oil. In any aspect or embodiment described herein, the hygroscopic liquid is brine (e.g., CaCl₂) brine, NaCl brine, NaBr brine, CaBr₂ brine, formate brines (such as, potassium formate), and the like) or alcohol based hygroscopic liquid (e.g., lower polyhydric alcohols, glycerol, polyglycerol, and the like). In any aspect or embodiment described herein, the oil:water ratio of the oil-based RDF is about 50:50 to about 95:5 (v/v). For example, in any aspect or embodiment described herein, the oil:water ratio of the oil-based RDF is about 50:50 to about 95:5 (v/v), about 50:50 to about 90:10 (v/v), about 50:50 to about 85:15 (v/v), about 50:50 to about 80:20 (v/v), about 50:50 to about 75:25 (v/v), about 50:50 to about 70:30 (v/v), about 50:50 to about 65:35 (v/v), about 50:50 to about 60:40 (v/v), about 55:45 to about 95:5 (v/v), about 55:45 to about 90:10 (v/v), about 55:45 to about 85:15 (v/v), about 55:45 to about 80:20 (v/v), about 55:45 to about 75:25 (v/v), about 55:45 to about 70:30 (v/v), about 55:45 to about 65:35 (v/v), about 60:40 to about 95:5 (v/v), about 60:40 to about 90:10 (v/v), about 60:40 to about 85:15 (v/v), about 60:40 to about 80:20 (v/v), about 60:40 to about 75:25 (v/v), about 60:40 to about 70:30 (v/v), about 65:35 to about 95:5 (v/v), about 65:35 to about 90:10 (v/v), about 65:35 to about 85:15 (v/v), about 65:35 to about 80:20 (v/v), about 65:35 to about 75:25 (v/v), about 70:30 to about 95:5 (v/v), about 70:30 to about 90:10 (v/v), about 70:30 to about 85:15 (v/v), about 70:30 to about 80:20 (v/v), about 75:25 to about 95:5 (v/v), about 75:25 to about 90:10 (v/v), about 75:25 to about 85:15 (v/v), about 80:20 to about 95:5 (v/v), about 80:20 to about 90:10 (v/v), about 85:15 to about 95:5 (v/v). In any aspect or embodiment described herein. Those skilled in the art appreciate that the aqueous concentration of the solute (e.g., salt or alcohol, such as glycerol) is determined by the water activity needed for the formation being drilled. See, e.g., FIGS. 2A and 3A of U.S. Pat. No. 5,198,416.

In any aspect or embodiment described herein, the oil-based RDF further comprises at least one of: (i) one or more emulsifiers (e.g., a primary emulsifier and a secondary emulsifier), (ii) one or more rheological modifiers, (iii) one or more alkalinity control agent, (iv) one or more wetting agent, (v) one or more corrosion inhibitor, or (vi) a combination thereof.

In any aspect or embodiment described herein, the emulsifier is at least one of: a modified tall oil (e.g., maleated tall oil), a modified fatty amine condensate (e.g., carboxylic acid terminated fatty amine condensate), or a combination thereof. In any aspect or embodiment described herein, the oil-based RDF includes one or more emulsifier is present in an amount of up to about 20 ppb. For example, in any aspect or embodiment described herein, the oil-based RDF includes one or more emulsifiers present in an amount of up to about 20 ppb, up to about 15 ppb, up to about 10 ppb, up to about 5 ppb, about 1.0 ppb to about 20 ppb, about 1.0 ppb to about 17.5 ppb, about 1.0 ppb to about 15 ppb, about 1.0 ppb to about 12.5 ppb, about 1.0 ppb to about 10 ppb, about 1.0 ppb to about 7.5 ppb, about 1.0 ppb to about 5 ppb, about 2.5 ppb to about 20.0 ppb, about 2.5 ppb to about 17.5 ppb, about 2.5 ppb to about 15 ppb, about 2.5 ppb to about 12.5 ppb, about 2.5 ppb to about 10 ppb, about 2.5 ppb to about 7.5 ppb, about 5.0 ppb to about 20 ppb, about 5.0 ppb to about 17.5 ppb, about 5.0 ppb to about 15 ppb, about 5.0 ppb to about 12.5 ppb, about 5.0 ppb to about 10 ppb, about 7.5 ppb to about 20.0 ppb, about 7.5 ppb to about 17.5 ppb, about 7.5 ppb to about 15 ppb, about 7.5 ppb to about 12.5 ppb, about 10.0 ppb to about 20.0 ppb, about 10.0 ppb to about 17.5 ppb, about 10.0 ppb to about 15 ppb, about 12.5 ppb to about 20.0 ppb, about 12.5 ppb to about 17.5 ppb, about 15.0 to about 20.0 ppb, or about 15.0 ppb to about 20.0 ppb.

In any aspect or embodiment described herein, the one more emulsifiers of the oil-based RDF includes a primary emulsifier that includes a modified tall oil (e.g., maleated tall oil) and a secondary emulsifier that includes a modified fatty amine condensate (e.g., carboxylic acid terminated fatty amine condensate). In any aspect or embodiment described herein, the primary emulsifier is present in an amount of up to about 15.0 ppb, up to about 12.5 ppb, up to about 10.0 ppb, up to about 7.5 ppb, up to about 5.0 ppb, up to about 2.5 ppb, about 1.0 ppb to about 15 ppb, about 1.0 ppb to about 12.5 ppb, about 1.0 ppb to about 10 ppb, about 1.0 ppb to about 7.5 ppb, about 1.0 ppb to about 5 ppb, about 2.5 ppb to about 15 ppb, about 2.5 ppb to about 12.5 ppb, about 2.5 ppb to about 10 ppb, about 2.5 ppb to about 7.5 ppb, about 5.0 ppb to about 15 ppb, about 5.0 ppb to about 12.5 ppb, about 5.0 ppb to about 10 ppb, about 7.5 ppb to about 15 ppb, about 7.5 ppb to about 12.5 ppb, or about 10.0 ppb to about 15 ppb. In any aspect or embodiment described herein, the secondary emulsifier is present in an amount of up to about 20 ppb, up to about 15 ppb, up to about 10 ppb, up to about 5 ppb, about 1.0 ppb to about 20 ppb, about 1.0 ppb to about 17.5 ppb, about 1.0 ppb to about 15 ppb, about 1.0 ppb to about 12.5 ppb, about 1.0 ppb to about 10 ppb, about 1.0 ppb to about 7.5 ppb, about 1.0 ppb to about 5 ppb, about 2.5 ppb to about 20.0 ppb, about 2.5 ppb to about 17.5 ppb, about 2.5 ppb to about 15 ppb, about 2.5 ppb to about 12.5 ppb, about 2.5 ppb to about 10 ppb, about 2.5 ppb to about 7.5 ppb, about 5.0 ppb to about 20 ppb, about 5.0 ppb to about 17.5 ppb, about 5.0 ppb to about 15 ppb, about 5.0 ppb to about 12.5 ppb, about 5.0 ppb to about 10 ppb, about 7.5 ppb to about 20.0 ppb, about 7.5 ppb to about 17.5 ppb, about 7.5 ppb to about 15 ppb, about 7.5 ppb to about 12.5 ppb, about 10.0 ppb to about 20.0 ppb, about 10.0 ppb to about 17.5 ppb, about 10.0 ppb to about 15 ppb, about 12.5 ppb to about 20.0 ppb, about 12.5 ppb to about 17.5 ppb, about 15.0 to about 20.0 ppb, or about 15.0 ppb to about 20.0 ppb.

In any aspect or embodiment described herein, the oil-based RDF further comprises a corrosion inhibitor (e.g., a sulfur containing compound, amine, or a combination thereof). In any aspect or embodiment described herein, the rheological modifier includes at least one of: an organic clay (e.g, bentonite or alkyl quaternary ammonium bentonite), a polyamide, a dimer diacid (e.g., Envamod® 595 available from Ingevity), or a combination thereof. For example, in any aspect or embodiment described herein, the rheological modifier is present in an amount of about 0.5 ppb to about 12.5 ppb, about 0.5 ppb to about 10 ppb, about 0.5 ppb to about 7.5 ppb, about 0.5 ppb to about 5 ppb, about 1.0 ppb to about 12.5 ppb, about 1.0 ppb to about 10 ppb, about 1.0 ppb to about 7.5 ppb, about 1.0 ppb to about 5 ppb, about 2.5 ppb to about 15 ppb, about 2.5 ppb to about 12.5 ppb, about 2.5 ppb to about 10 ppb, about 2.5 ppb to about 7.5 ppb, about 5.0 ppb to about 15 ppb, about 5.0 ppb to about 12.5 ppb, about 5.0 ppb to about 10 ppb, about 7.5 ppb to about 15 ppb, about 7.5 ppb to about 12.5 ppb, or about 10.0 ppb to about 15 ppb. In any aspect or embodiment described herein, the rheological modifier is an organoclay or bentonite clay that is present in an amount of about 0.5 ppb to about 12.5 ppb, about 0.5 ppb to about 10 ppb, about 0.5 ppb to about 7.5 ppb, about 0.5 ppb to about 5 ppb, about 1.0 ppb to about 12.5 ppb, about 1.0 ppb to about 10 ppb, about 1.0 ppb to about 7.5 ppb, about 1.0 ppb to about 5 ppb, about 2.5 ppb to about 15 ppb, about 2.5 ppb to about 12.5 ppb, about 2.5 ppb to about 10 ppb, about 2.5 ppb to about 7.5 ppb, about 5.0 ppb to about 15 ppb, about 5.0 ppb to about 12.5 ppb, about 5.0 ppb to about 10 ppb, about 7.5 ppb to about 15 ppb, about 7.5 ppb to about 12.5 ppb, or about 10.0 ppb to about 15 ppb. In any aspect or embodiment described herein, the rheological modifier is a liquid polymeric viscosifier of up to about 4.0 ppb, up to about 3.5 ppb, up to about 3.0 ppb, up to about 2.5 ppb, up to about 2.0 ppb, up to about 1.5 ppb, up to about 1.0 ppb, up to about 0.5 ppb, about 0.25 ppb to about 4.00 ppb, about 0.25 ppb to about 3.50 ppb, about 0.25 ppb to about 3.00 ppb, about 0.25 ppb to about 2.50 ppb, about 0.25 ppb to about 2.00 ppb, about 0.25 ppb to about 1.50 ppb, about 0.25 ppb to about 1.00 ppb, about 0.50 ppb to about 4.00 ppb, about 0.50 ppb to about 3.50 ppb, about 0.50 ppb to about 3.00 ppb, about 0.50 ppb to about 2.50 ppb, about 0.50 ppb to about 2.00 ppb, about 0.50 ppb to about 1.50 ppb, about 0.50 ppb to about 1.00 ppb, about 1.00 ppb to about 4.00 ppb, about 1.00 ppb to about 3.50 ppb, about 1.00 ppb to about 3.00 ppb, about 1.00 ppb to about 2.50 ppb, about 1.00 ppb to about 2.00 ppb, about 1.00 ppb to about 1.50 ppb, about 1.50 ppb to about 4.00 ppb, about 1.50 ppb to about 3.50 ppb, about 1.50 ppb to about 3.00 ppb, about 1.50 ppb to about 2.50 ppb, about 1.50 ppb to about 2.00 ppb, about 2.00 ppb to about 4.00 ppb, about 2.00 ppb to about 3.50 ppb, about 2.00 ppb to about 3.00 ppb, about 2.00 ppb to about 2.50 ppb, about 2.50 ppb to about 4.00 ppb, about 2.50 ppb to about 3.50 ppb, about 2.50 ppb to about 3.00 ppb, about 3.00 ppb to about 4.00 ppb, about 3.00 ppb to about 3.50 ppb, and about 3.50 ppb to about 4.00 ppb.

In any aspect or embodiment described herein, the oil-based RDF further comprises one or more wetting agent (e.g., fatty imidazolines, soya lecithin, or combinations thereof). For example, in any aspect or embodiment described herein, the oil-based RDF further comprising one or more wetting agent that is present in an amount of up to about 3.0 ppb, up to about 2.5 ppb, up to about 2.0 ppb, up to about 1.5 ppb, up to about 1.0 ppb, up to about 0.5 ppb, about 0.25 ppb to about 3.00 ppb, about 0.25 ppb to about 2.50 ppb, about 0.25 ppb to about 2.00 ppb, about 0.25 ppb to about 1.50 ppb, about 0.25 ppb to about 1.00 ppb, about 0.50 ppb to about 3.00 ppb, about 0.50 ppb to about 2.50 ppb, about 0.50 ppb to about 2.00 ppb, about 0.50 ppb to about 1.50 ppb, about 0.50 ppb to about 1.00 ppb, about 1.00 ppb to about 3.00 ppb, about 1.00 ppb to about 2.50 ppb, about 1.00 ppb to about 2.00 ppb, about 1.00 ppb to about 1.50 ppb, about 1.50 ppb to about 3.00 ppb, about 1.50 ppb to about 2.50 ppb, about 1.50 ppb to about 2.00 ppb, about 2.00 ppb to about 3.00 ppb, about 2.00 ppb to about 2.50 ppb, or about 2.50 ppb to about 3.00 ppb).

In any aspect or embodiment described herein, the oil-based RDF further comprises one or more alkalinity control agent (e.g., lime Ca(OH)). For example, in any aspect or embodiment described herein, the one or more alkalinity control agent is present in the oil-based RDF in an amount of up to about 8.0 ppb, up to about 7.0 ppb, up to about 6.0 ppb, up to about 5.0 ppb, up to about 4.0 ppb, up to about 3.0 ppb, up to about 2.0 ppb, up to about 1.0 ppb, about 1.0 ppb to about 8.0 ppb, about 1.0 ppb to about 7.0 ppb, about 1.0 ppb to about 6.0 ppb, about 1.0 ppb to about 5.0 ppb, about 1.0 ppb to about 4.0 ppb, about 1.0 ppb to about 3.0 ppb, about 1.0 ppb to about 2.0 ppb, about 2.0 ppb to about 8.0 ppb, about 2.0 ppb to about 7.0 ppb, about 2.0 ppb to about 6.0 ppb, about 2.0 ppb to about 5.0 ppb, about 2.0 ppb to about 4.0 ppb, about 2.0 ppb to about 3.0 ppb, about 3.0 ppb to about 8.0 ppb, about 3.0 ppb to about 7.0 ppb, about 3.0 ppb to about 6.0 ppb, about 3.0 ppb to about 5.0 ppb, about 3.0 ppb to about 4.0 ppb, about 4.0 ppb to about 8.0 ppb, about 4.0 ppb to about 7.0 ppb, about 4.0 ppb to about 6.0 ppb, about 4.0 ppb to about 5.0 ppb, about 5.0 ppb to about 8.0 ppb, about 5.0 ppb to about 7.0 ppb, about 5.0 ppb to about 6.0 ppb, about 6.0 ppb to about 8.0 ppb, about 6.0 ppb to about 7.0 ppb, or about 7.0 ppb to about 8.0 ppb.

In any aspect or embodiment described herein, the oil-based RDF further comprises one or more weighting or bridging agent present in an amount of about 2.5 to about 45.0% V/V of the oil-based RDF, wherein one or more of: (i) at least about 50% V/V of the one or more weighting or bridging agent is acid soluble; (ii) no more than 10% V/V of the one or more weighting or bridging agent is acid insoluble; or (iii) a combination thereof. For example, in any aspect or embodiment described herein, one or more weighting or bridging agent is present in the oil-based RDF in an amount of about 2.5 to about 45.0%, about 2.5 to about 40.0%, about 2.5 to about 35.0%, about 2.5 to about 30.0%, about 2.5 to about 25.0%, about 2.5 to about 20.0%, about 2.5 to about 15.0%, about 2.5 to about 10.0%, about 5.0 to about 45.0%, about 5.0 to about 40.0%, about 5.0 to about 35.0%, about 5.0 to about 30.0%, about 5.0 to about 25.0%, about 5.0 to about 20.0%, about 5.0 to about 15.0%, about 10.0 to about 45.0%, about 10.0 to about 40.0%, about 10.0 to about 35.0%, about 10.0 to about 30.0%, about 10.0 to about 25.0%, about 10.0 to about 20.0%, about 15.0 to about 45.0%, about 15.0 to about 40.0%, about 15.0 to about 35.0%, about 15.0 to about 30.0%, about 15.0 to about 25.0%, about 20.0 to about 45.0%, about 20.0 to about 40.0%, about 20.0 to about 35.0%, about 20.0 to about 30.0%, about 25.0 to about 45.0%, about 25.0 to about 40.0%, about 25.0 to about 35.0%, about 30.0 to about 45.0%, about 30.0 to about 40.0%, or about 35.0 to about 45.0% V/V of the oil-based RDF.

Furthermore, in any aspect or embodiment described herein, the one or more weighting or bridging agent of the oil-based RDF includes at least about 50%, at least about 55%, at least about 60%, at least about 65%, at least about 70%, at least about 75%, at least about 80%, at least about 85%, at least about 90%, at least about 95%, at least 99%, about 50% to about 95%, about 50% to about 90%, about 50% to about 85%, about 50% to about 80%, about 50% to about 75%, about 50% to about 70%, about 50% to about 65%, about 50% to about 60%, about 55% to about 95%, about 55% to about 90%, about 55% to about 85%, about 55% to about 80%, about 55% to about 75%, about 55% to about 70%, about 55% to about 65%, about 60% to about 95%, about 60% to about 90%, about 60% to about 85%, about 60% to about 80%, about 60% to about 75%, about 60% to about 70%, about 65% to about 95%, about 65% to about 90%, about 65% to about 85%, about 65% to about 80%, about 65% to about 75%, about 70% to about 95%, about 70% to about 90%, about 70% to about 85%, about 70% to about 80%, about 75% to about 95%, about 75% to about 90%, about 75% to about 85%, about 80% to about 95%, about 80% to about 90%, or about 85% to about 95% V/V of at least one (e.g., 1, 2, 3, 4, 5, 6, or more) acid soluble weighting or bridging agent. For example, in any aspect or embodiment described herein, the acid soluble weighting or bridging agent includes or is at least one of calcium carbonate (CaCO₃), manganese oxide (Mn₃O₄), ilmenite, or a combination thereof.

Additionally, in any aspect or embodiment described herein, the one or more weighting or bridging agent of the oil-based RDF includes no more than 10%, no more than 9.5%, no more than 9.0%, no more than 8.5%, no more than 8.0%, no more than 7.5%, no more than 7.0%, no more than 6.5%, no more than 6.0%, no more than 5.5%, no more than 5.0%, no more than 4.5%, no more than 4.0%, no more than 3.5%, no more than 3.0%, no more than 2.5%, no more than 2.0%, no more than 1.5%, no more than 1.0%, about 0.5% to about 10.0%, about 0.5% to about 9.0%, about 0.5% to about 8.0%, about 0.5% to about 7.0%, about 0.5% to about 6.0%, about 0.5% to about 5.0%, about 0.5% to about 4.0%, about 0.5% to about 3.0%, about 0.5% to about 2.0%, about 1.0% to about 10.0%, about 1.0% to about 9.0%, about 1.0% to about 8.0%, about 1.0% to about 7.0%, about 1.0% to about 6.0%, about 1.0% to about 5.0%, about 1.0% to about 4.0%, about 1.0% to about 3.0%, about 1.0% to about 2.0%, about 2.0% to about 10.0%, about 2.0% to about 9.0%, about 2.0% to about 8.0%, about 2.0% to about 7.0%, about 2.0% to about 6.0%, about 2.0% to about 5.0%, about 2.0% to about 4.0%, about 2.0% to about 3.0%, about 3.0% to about 10.0%, about 3.0% to about 9.0%, about 3.0% to about 8.0%, about 3.0% to about 7.0%, about 3.0% to about 6.0%, about 3.0% to about 5.0%, about 3.0% to about 4.0%, about 4.0% to about 10.0%, about 4.0% to about 9.0%, about 4.0% to about 8.0%, about 4.0% to about 7.0%, about 4.0% to about 6.0%, about 4.0% to about 5.0%, about 5.0% to about 10.0%, about 5.0% to about 9.0%, about 5.0% to about 8.0%, about 5.0% to about 7.0%, about 5.0% to about 6.0%, about 6.0% to about 10.0%, about 6.0% to about 9.0%, about 6.0% to about 8.0%, about 6.0% to about 7.0%, about 7.0% to about 10.0%, about 7.0% to about 9.0%, about 7.0% to about 8.0%, about 8.0% to about 10.0%, about 8.0% to about 9.0%, or about 9.0% to about 10.0% V/V of at least one (e.g., 1, 2, 3, 4, 5, 6, or more) acid insoluble weighting or bridging agent. For example, in any aspect or embodiment described herein, the acid insoluble weighting or bridging agent includes or is barite. In any aspect or embodiment described herein, the acid insoluble weighting or bridging agent includes at least one of: insoluble components present in trimanganese tetraoxide, insoluble components present in ilmenite, insoluble components present in hematite, or a combination thereof.

Method of Making Oil-Based RDF Composition or Additive

Another aspect of the present disclosure provides a method of making oil-based RDF additive of the present disclosure. The method comprises: blending (A) one or more hydrophobizing component or agent, as described herein, and (B) one or more phenolic material or composition comprising phenolic polymers or salts thereof, as described herein.

In any aspect or embodiment described herein, at least one of: the blending is performed under conditions that results in a reaction product of the blended components, as described herein; the phenolic polymers are cross-linked; the hydrophobizing component or agent is compound comprising an amine, an amide, or both; the phenolic material or composition includes lignin, lignin derivative, or salts thereof.

In any aspect or embodiment described herein, at least one of: (A) the lignin derivative is selected from the group consisting of: a first sulfonated lignin compound having a sulfonate group located on aliphatic part of the lignin, a second sulfonated lignin compound having a sulfonate group located on aromatic part of the lignin, a third sulfonated lignin compound having a sulfonate group located on aromatic part of the lignin and another sulfonate group located on aliphatic part of the lignin, alkoxylated lignin (e.g., ethoxylated lignin or propoxylated lignin), esterified lignin (e.g., lignin esterified at the hydroxyl group, the carboxyl group, or both), hydroxypropylated lignin, phenolated lignin, alkylated lignin, urethanized lignin, hydroxyalkylated lignin, sulfomethylated lignin, nitrated lignin (e.g., a nitro group added to at least one aromatic group of the lignin), azo coupled lignin (e.g., azo group coupled to at least one aromatic group of the lignin), and combinations thereof; and (B) the phenolic material or composition includes at least one of: Organosolv lignin, milled wood lignin, cellulotic enzyme lignin, enzymatic mild acidolysis lignin, lignin extracted with ionic liquids, slurry A, slurry C, Indulin AT, Indulin C, black liquor, Kraft lignosulfonates, Kraft lignin, sulfite lignin, sulfomethylated Kraft lignin, derivatives thereof, and salts thereof.

In any aspect or embodiment of the method described herein, the lignin derivative includes or is the first sulfonated lignin compound having a sulfonate group located on aliphatic part of the lignin and having a degree of sulfonation between about 0.1 and about 4.0 (e.g., about 1.2 to about 2.2).

In any aspect or embodiment described herein, the method of making the oil-based RDF additive of the present disclosure further comprises: (a) preparing an aqueous solution of one or more phenolic material or composition, as described herein (e.g., a lignin derivative as described herein), that comprises about 5 to about 55 percent by weight of the aqueous solution; (b) mixing the aqueous solution of lignin derivative with one or more hydrophobizing component or agent, as described herein; and (c) optionally adding formaldehyde, as described herein (e.g., formalin), to the mixture of step (b). In any aspect or embodiment described herein, the method of making the oil-based RDF additive of the present disclosure further comprises, heating the mixture (e.g., the phenolic material or composition, the hydrophobizing component or agent, and optionally, formaldehyde, each of which is described herein) to a temperature of about 25 to about 120° C. (e.g, about 60 to about 95° C.). For example, in any aspect or embodiment described herein, the method may comprise heating the mixture or blend for a period of at least about 1 minute (e.g., a period of about 1 minute to about 24 hours, or about 1 minute to about 18 hours, about 1 minute to about 14 hour, or about 1 minute to about 6 hours). By way of further example, in any aspect or embodiment described herein, the mixture it heated to a temperature of about 25 to about 120° C., about 25 to about 110° C., about 25 to about 100° C., about 25 to about 90° C., about 25 to about 80° C., about 25 to about 70° C., about 25 to about 60° C., about 25 to about 50° C., about 25 to about 40° C., about 30 to about 120° C., about 30 to about 110° C., about 30 to about 100° C., about 30 to about 90° C., about 30 to about 80° C., about 30 to about 70° C., about 30 to about 60° C., about 30 to about 50° C., about 30 to about 40° C., about 40 to about 120° C., about 40 to about 110° C., about 40 to about 100° C., about 40 to about 90° C., about 40 to about 80° C., about 40 to about 70° C., about 40 to about 60° C., about 40 to about 50° C., about 50 to about 120° C., about 50 to about 110° C., about 50 to about 100° C., about 50 to about 90° C., about 50 to about 80° C., about 50 to about 70° C., about 50 to about 60° C., about 60 to about 120° C., about 60 to about 110° C., about 60 to about 100° C., about 60 to about 90° C., about 60 to about 80° C., about 60 to about 70° C., about 70 to about 120° C., about 70 to about 110° C., about 70 to about 100° C., about 70 to about 90° C., about 70 to about 80° C., about 80 to about 120° C., about 80 to about 110° C., about 80 to about 100° C., about 80 to about 90° C., about 90 to about 120° C., about 90 to about 110° C., about 90 to about 100° C., about 100 to about 120° C., about 100 to about 110° C., or about 110 to about 120° C.

In any aspect or embodiment described herein, the phenolic material or composition is an aqueous solution that includes, e.g., at least one of: lignin, the lignin derivative, and salts thereof, and the lignin, the lignin derivative, salts thereof, or combination thereof, is present in an amount of about 5 to about 55, about 5 to about 50, about 5 to about 45, about 5 to about 40, about 5 to about 35, about 5 to about 30, about 5 to about 25, about 5 to about 20, about 5 to about 15, about 10 to about 55, about 10 to about 50, about 10 to about 45, about 10 to about 40, about 10 to about 35, about 10 to about 30, about 10 to about 25, about 10 to about 20, about 15 to about 55, about 15 to about 50, about 15 to about 45, about 15 to about 40, about 15 to about 35, about 15 to about 30, about 15 to about 25, about 20 to about 55, about 20 to about 50, about 20 to about 45, about 20 to about 40, about 20 to about 35, about 20 to about 30, about 25 to about 55, about 25 to about 50, about 25 to about 45, about 25 to about 40, about 25 to about 35, about 30 to about 55, about 30 to about 50, about 30 to about 45, about 30 to about 40, about 35 to about 55, about 35 to about 50, about 35 to about 45, about 40 to about 55, about 40 to about 50, about 45 to about 55 percent by weight of an aqueous solution.

In any aspect or embodiment described herein, the method further comprises spray drying the blend, reaction product, or mixture thereof, to obtain a powder from the blend, reaction product, or mixture thereof.

In any aspect or embodiment described herein, the lignin derivative includes or is the second sulfonated lignin compound having a sulfonate group located on aromatic part of the lignin, and having a degree of sulfonation between about 0.1 and about 4 (e.g., about 0.1 to about 2.9).

Method of Drilling a Reservoir Section of a Wellbore

An additional aspect of the present disclosure related to a method of drilling a reservoir section of a wellbore. The method comprises circulating an oil-based RDF when: the drill penetrates the reservoir section, the drill is drilling the reservoir section, or both, wherein the oil-based RDF includes the oil-based RDF additive, fluid-loss additive, or composition of the present disclosure. In any aspect or embodiment described herein, the oil-based (RDF) comprises one or more weighting or bridging agent as described herein. For example, in any aspect or embodiment described herein, the one or more weighting or bridging agents is present in an amount of about 2.5 to about 45% V/V of the oil-based RDF, wherein: (i) at least about 50% of the one or more weighting or bridging agent is acid soluble, (ii) no more than about 10% of the one or more weighting or bridging agent is acid insoluble, or (iii) a combination thereof.

In any aspect or embodiment described herein, the method further comprises, after circulating the oil-based RDF, at least one of: (i) removing the oil-based RDF, (ii) removing a filter cake by treating the filter cake with a filter cake breaker fluid through the wellbore, or (iii) both. In any aspect or embodiment described herein, the method further comprises, after circulating the oil-based RDF, at least one of: (i) removing the oil-based RDF, (ii) treating a filter cake with a filter cake breaker fluid through the wellbore, or (iii) both. In any aspect or embodiment described herein, treating the filter cake includes at least one of: (i) spotting the filter cake breaker in place and soaking the filter cake with the filter cake breaker fluid (e.g., soaking for about 2 hours to about 72 hours, about 2 hours to about 60 hours, about 2 hours to about 45 hours, about 2 hours to about 30 hours, about 2 hours to about 15 hours, about 10 hours to about 72 hours, about 10 hours to about 60 hours, about 10 hours to about 45 hours, about 10 hours to about 30 hours, about 20 hours to about 72 hours, about 20 hours to about 60 hours, about 20 hours to about 45 hours, about 20 hours to about 30 hours, about 30 hours to about 72 hours, about 30 hours to about 60 hours, about 302 hours to about 45 hours, about 40 hours to about 72 hours, about 10 hours to about 60 hours, about 50 hours to about 72 hours, about 50 hours to about 60 hours, or about 60 hours to about 72 hours), (ii) circulating the filter cake breaker fluid; (iii) removing the filter cake breaker fluid (e.g., displaced during producing from the wellbore); or (iv) a combination thereof. In any aspect or embodiment described herein, removing the oil-based RDF includes displacing the oil-based RDF with completion brine (e.g., a brine as described herein). In any aspect or embodiment described herein, removing the oil-based RDF further includes running completion assembly (e.g., sand screens, gravel pack, and the like).

In any aspect or embodiment described herein, the filter cake breaker fluid comprises at least one of: (i) a brine (e.g., NaCl brine, NaBr brine, CaCl₂) brine, CaBr₂ brine, or the like); (ii) one or more acid or acid precursor (e.g., citric acid, acetic acid, esters, orthoesters (such as trimethyl orthoacetate, triethyl orthoacetate, tripropyl orthoacetate, triisopropyl orthoacetate, polyorthoacetate, trimethyl orthoformate, triethyl ortho formate, tripropyl orthoformate, triisopropyl orthoformate, polyorthoformates, trimethyl orthopropionate, and/or triethyl orthopropionate), and/or hydrochloric acid (HCl)); (iii) one or more complexing agents (e.g., complexing agents that chelate ions of the weighting or bridging agent or agents); (iv) one or more solvent (e.g., one or more of ethylene glycol monobutyl ether, propylene glycol monobutyl ether, methanol, isopropyl alcohol, and the like); (v) one or more surfactant (e.g., a one or more water wetting surfactant to make the filter cake components water wet; e.g., one or more of amine ethoxylate, cocoamido propyl betaine, fatty alcohol ethoxylates, polyoxyethylenesorbitan monolaurate 20 (such as Tween® 20), polyoxyethylenesorbitan monolaurate 80 (such as Tween® 80), and the like); (vi) one or more pH control agent (e.g., sodium bicarbonate); (vii) one or more corrosion inhibitor (e.g., one or more of a sulfur containing compound and quaternary organic ammonium salt); (viii) one or more viscosifier (e.g., hydroxyethyl cellulose); or (ix) a combination therefore.

In any aspect or embodiment described herein, the complexing agents includes at least one of: ethylene diamine tetra-acetic acid (EDTA), nitrilotriacetic acid (NTA), diethylene triamine pentaacetic acid (DTPA), propylene diamine tetraacetic acid (PDTA), ethylenediamine-N,N″-di(hydroxyphenyl) acetic acid (EDDHA), ethylenediamine-N,N″-di(hydroxy-methylphenyl) acetic acid EDDHMA), glutamic acid N,N-diacetic acid (GLDA), and the like. Generally, complexing agent(s) is utilized in filter cake breaker fluids that lack acids or acid precursors. Thus, in any aspect or embodiment described herein, the filter cake breaker fluid comprises either (i) one or more acid or acid precursor or (ii) one or more complexing agent. The pH control agent(s) and viscosifier(s) are generally utilized when the filter cake breaker fluid includes one or more complexing agent or one or more precursor acids (such described herein, such as esters of organic acid). Thus, in any aspect or embodiment described herein, when the filter cake breaker fluid includes (i) one or more complexing agent or (ii) one or more precursor acids, the filter cake breaker fluid further includes at least one of: one or more pH control agent (e.g., sodium bicarbonate), one or more viscosifier (e.g., hydroxyethyl cellulose), or a combination thereof.

In any aspect or embodiment described herein, the brine of the filter cake breaker fluid has a density of about 1.0 to about 1.9 S.G. (e.g., about 1.0 to about 1.9, about 1.0 to about 1.8, about 1.0 to about 1.7, about 1.0 to about 1.6, about 1.0 to about 1.5, about 1.0 to about 1.4, about 1.1 to about 1.9, about 1.1 to about 1.8, about 1.1 to about 1.7, about 1.1 to about 1.6, about 1.1 to about 1.5, about 1.2 to about 1.9, about 1.2 to about 1.8, about 1.2 to about 1.7, about 1.2 to about 1.6, about 1.3 to about 1.9, about 1.3 to about 1.8, about 1.3 to about 1.7, about 1.4 to about 1.9, about 1.4 to about 1.8, about 1.4 to about 1.7, about 1.5 to about 1.9, about 1.5 to about 1.8, about 1.6 to about 1.9 S.G). In any aspect or embodiment described herein, the brine of the filter cake breaker fluid is present in an amount of about 30% to about 90% of the filter cake breaker fluid. For example, in any aspect or embodiment described herein, the brine of the filter cake breaker fluid is present in an amount of about 30% to about 90%, about 30% to about 80%, about 30% to about 70%, about 30% to about 60%, about 30% to about 50%, about 30% to about 40%, about 40% to about 90%, about 40% to about 80%, about 40% to about 70%, about 40% to about 60%, about 40% to about 50%, about 50% to about 90%, about 50% to about 80%, about 50% to about 70%, about 50% to about 60%, about 60% to about 90%, about 60% to about 80%, about 60% to about 70%, about 70% to about 90%, about 70% to about 80%, or about 80% to about 90% of the filter cake breaker fluid.

In any aspect or embodiment described herein, the one or more acid or precursor acid is present in an amount of about 5% to about 40% v/v of the filter cake breaker fluid. For example, in any aspect or embodiment described herein, the acid(s) and/or precursor acid(s) is present in an amount of about 5% to about 40%, about 5% to about 35%, about 5% to about 30%, about 5% to about 25%, about 5% to about 20%, about 5% to about 15%, about 10% to about 40%, about 10% to about 35%, about 10% to about 30%, about 10% to about 25%, about 10% to about 20%, about 15% to about 40%, about 15% to about 35%, about 15% to about 30%, about 15% to about 25%, about 20% to about 40%, about 20% to about 35%, about 20% to about 30%, about 25% to about 40%, about 25% to about 35%, or about 30% to about 40% v/v of the filter cake breaker fluid.

In any aspect or embodiment described herein, the one or more complexing agent is present in an amount of about 1% to about 40% v/v of the filter cake breaker fluid. For example, in any aspect or embodiment described herein, the complexing agent or agents is/are present in an amount of about 1% to about 40%, about 1% to about 35%, about 1% to about 30%, about 1% to about 25%, about 1% to about 20%, about 1% to about 15%, about 1% to about 10%, about 5% to about 40%, about 5% to about 35%, about 5% to about 30%, about 5% to about 25%, about 5% to about 20%, about 5% to about 15%, about 10% to about 40%, about 10% to about 35%, about 10% to about 30%, about 10% to about 25%, about 10% to about 20%, about 15% to about 40%, about 15% to about 35%, about 15% to about 30%, about 15% to about 25%, about 20% to about 40%, about 20% to about 35%, about 20% to about 30%, about 25% to about 40%, about 25% to about 35%, or about 30% to about 40% v/v of the filter cake breaker fluid.

In any aspect or embodiment described herein, the one or more solvent or mutual solvent is present in an amount of about 5% to about 40% v/v of the filter cake breaker fluid. For example, in any aspect or embodiment described herein, the solvent or mutual solvent is present in an amount of about 5% to about 40%, about 5% to about 35%, about 5% to about 30%, about 5% to about 25%, about 5% to about 20%, about 5% to about 15%, about 10% to about 40%, about 10% to about 35%, about 10% to about 30%, about 10% to about 25%, about 10% to about 20%, about 15% to about 40%, about 15% to about 35%, about 15% to about 30%, about 15% to about 25%, about 20% to about 40%, about 20% to about 35%, about 20% to about 30%, about 25% to about 40%, about 25% to about 35%, or about 30% to about 40% v/v of the filter cake breaker fluid.

In any aspect or embodiment described herein, the one or more water wetting surfactant is present in an amount of up to about 5.0% v/v of the filter cake breaker fluid. For example, in any aspect or embodiment described herein, the one or more wetting surfactant is present in an amount of up to about 5.0%, up to about 4.0%, up to about 3.0%, up to about 2.0%, up to about 1.0%, about 0.5% to about 5.0%, about 0.5% to about 4.0%, about 0.5% to about 3.0%, about 0.5% to about 2.0%, about 0.5% to about 1.0%, about 1.0% to about 5.0%, about 1.0% to about 4.0%, about 1.0% to about 3.0%, about 1.0% to about 2.0%, about 2.0% to about 5.0%, about 2.0% to about 4.0%, about 2.0% to about 3.0%, about 3.0% to about 5.0%, about 3.0% to about 4.0%, or about 4.0% to about 5.0% v/v of the filter cake breaker fluid.

In any aspect or embodiment described herein, the one or more corrosion inhibitor is present in an amount of up to about 2.0% v/v of the filter cake breaker fluid. For example, in any aspect or embodiment described herein, the one or more corrosion inhibitor is present in an amount of up to about 2.0%, up to about 1.5%, up to about 1.0%, up to about 0.50%, about 0.25% to about 2.00%, about 0.50% to about 2.00%, about 0.75% to about 2.00%, about 1.00% to about 2.00%, about 1.25% to about 2.00%, about 1.50% to about 2.00%, about 0.25% to about 1.75%, about 0.50% to about 1.75%, about 0.75% to about 1.75%, about 1.00% to about 1.75%, about 1.25% to about 1.75%, about 0.25% to about 1.50%, about 0.50% to about 1.50%, about 0.75% to about 1.50%, about 1.00% to about 1.50%, about 0.25% to about 1.25%, about 0.50% to about 1.25%, about 0.75% to about 1.25%, about 0.25% to about 1.00%, about 0.50% to about 1.00%, or about 0.25% to about 0.75% w/v of the filter cake breaker fluid.

In any aspect or embodiment described herein, the one or more viscosifier is present in an amount of up to about 1.00% w/v of the filter cake breaker fluid. For example, in any aspect or embodiment described herein the viscosifier is present in an amount of up to about 1.0%, up to about 0.80%, up to about 0.60%, up to about 0.40%, up to about 0.20%, about 0.1% to about 1.0%, about 0.1% to about 0.8%, about 0.1% to about 0.6%, about 0.1% to about 0.4%, about 0.2% to about 1.0%, about 0.2% to about 0.8%, about 0.2% to about 0.6%, about 0.2% to about 0.4%, about 0.3% to about 1.0%, about 0.3% to about 0.8%, about 0.3% to about 0.6%, about 0.4% to about 1.0%, about 0.4% to about 0.8%, about 0.4% to about 0.6%, about 0.5% to about 1.0%, about 0.5% to about 0.8%, or about 0.6% to about 0.8% of the filter cake breaker fluid.

In any aspect or embodiment described herein, the reservoir section has a permeability of about 10 millidarcy (mD) to about 2000 mD. For example, in any aspect or embodiment described herein, the reservoir section has a permeability of about 10 mD to about 2000 mD, about 10 mD to about 1500 mD, about 10 mD to about 1000 mD, about 10 mD to about 500 mD, about 20 mD to about 2000 mD, about 20 mD to about 1500 mD, about 20 mD to about 1000 mD, about 20 mD to about 500 mD, about 500 mD to about 2000 mD, about 500 mD to about 1500 mD, about 500 mD to about 1000 mD, about 1000 mD to about 2000 mD, about 1000 mD to about 1500 mD, or about 1500 mD to about 2000 mD.

In any aspect or embodiment described herein, removing the filter cake returns the permeability of the reservoir section to at least about 50% of permeability of the reservoir section prior to drilling. For example, in any aspect or embodiment described herein, removing the filter cake returns the permeability of the reservoir section to at least about 50%, at least about 55%, at least about 60%, at least about 65%, at least about 70%, at least about 75%, at least about 80%, at least about 85%, at least about 90%, about 50% to about 90%, about 50% to about 80%, about 50% to about 70%, about 50% to about 60%, about 60% to about 90%, about 60% to about 80%, about 60% to about 70%, about 70% to about 90%, about 80% to about 80%, or about 80% to about 90% of permeability of the reservoir section prior to drilling

In any aspect or embodiment described herein, the method further comprises, prior to circulating the oil-based RDF, at least one of: (i) circulating a drilling fluid through the wellbore when drilling (e.g., at least one of: when drilling the well to depth, not when the drill penetrates the reservoir section, not when the drill is drilling the reservoir section, or a combination thereof), (ii) removing the drilling fluid from the wellbore, or (iii) a combination thereof. In any aspect or embodiment described herein, the drilling fluid comprises: an invert emulsion of a hygroscopic liquid (e.g., a brine, such as CaCl₂) brine), an oil (e.g. diesel oil or a low sulfur diesel oil), mineral oil, and internal olefin. In any aspect or embodiment described herein, removing the fluid includes displacing the fluid with competition brine (e.g., a brine as described herein).

The foregoing and other embodiments are further illustrated by the following examples, which are not intended to limit the effective scope of the claims. All parts and percentages in the examples and throughout the specification and claims are by weight of the final composition unless otherwise specified.

### EXAMPLES

Acid Number and Amine Value Determination. Two grams of the low titer fatty acid material or amine material was added to a beaker. The low titer fatty acid material was dissolved in methanol or a mixture of methanol and Toluene or isopropanol using agitation and/or heat, as required for complete dissolution. The amine material was dissolved in 75 mL of isopropanol, using agitation and/or heat, as required for complete dissolution. Acid number was determined via titration with 0.5N KOH in methanol and the amine value was determined via titration with 0.5 HCL in methanol on a 888 Titrando Autotitrator (Metrohm, Riverview, Fla.).

### Example 1: Method for Making the Fluid Loss Control Additive Comprising Fatty Amine/Immidazoline

The method is explained with references to “FLA-1” in Table 1 below, as an example. A 20% w/w (solids) aqueous solution of the Reax 85A was prepared with a pH of 10-11, adjusted with 50% NaOH. About 625 gms of this 20% w/w Reax 85A solution was transferred into a 5-neck 1 liter round bottom flask and placed in a heating mantle. The flask was warmed to 65° C. with stirring at roughly 120 rpm, and held at 65° C. for 20 mins. Then, 125 gms of PC-2144 (a fatty imidazoline available from Ingevity Corporation, it has an Amine Value between 240-270) was added to the 1 liter round bottom flask for a total of 250 gms of active material. The pH of the reaction mixture in the round bottom flask was ensured to be between 10 and 11 so that the lignin derivative is soluble in the aqueous phase and available for the reaction. The reaction mixture was then heated to and held at 90° C. for about 4.5 hours, and then cooled to give an additive with 35% w/w solids activity. Similarly, the additive can be prepared at higher solids activity, as shown in the Table 1 with FLA-2 having 41.65% w/w solids activity and FLA-3 having 48.2% w/w solids activity.

TABLE 1
Exemplary fluid-loss additive comprising a lignin derivatives and a fatty amine.

| | | | | Deg. of | | | Wt. of | Wt. of | Wt. of | Tot. | Determined | |
|---|---|---|---|---|---|---|---|---|---|---|---|---|
| | | | | Sulpho- | | | PC-2144 | Lignin Deri. | slurry of | wt. in | Activity | |
| | | PC - | Lignin | nation | | | for 250 | for 250 | lignin | rxn | % w/w | |
| | HCHO | 2144- | Deri. | of lignin | Time | Lignin | gms active | gms active | Deri. | flask, | solids in | Final |
| Identity | wt % | wt % | wt % | Deri. | (hrs) | Deri. | material | material | (gms) | gms | rxn flask | pH |
| FLA-1 | 0 | 50 | 50 | 0.9 | 4.5 | Reax | 125 | 125 | 625 | 750 | 35% | 10.1 |
| | | | | | | 85A | | | (20% w/w | | | |
| | | | | | | | | | solids) | | | |
| FLA-2 | 0 | 50 | 50 | 0.9 | 4.5 | Reax | 250 | 250 | 1000 | 1250 | 41.65% | 10.56 |
| | | | | | | 85A | | | (25% w/w | | | |
| | | | | | | | | | solids) | | | |
| FLA-3 | 0 | 50 | 50 | 0.9 | 4.5 | Reax | 375 | 375 | 1295.3 | 1670.3 | 48.2% | 10.88 |
| | | | | | | 85A | | | (28.95% | | | |
| | | | | | | | | | solids) | | | |
| FLA-4 | 0 | 50 | 50 | 0.9 | 4.5 | Reax | 395 | 395 | 1834.6 | 2229.6 | 36.45% | 10.88 |
| | | | | | | 85A | | | (21.53% | | | |
| | | | | | | | | | solids) | | | |

### Example 2: Fluid-Loss Performance Testing in an Oil-Based Reservoir Drill-in Fluid

### Example 2.1: Preparation of an Oil-Based Drill-in Fluid

Several oil-based reservoir drill-in fluids (RDF) were prepared according to the compositions shown in Table 2, with the exception that they used different materials as fluid-loss control additives. Thus, Table 2 below shows representative composition of the oil-based RDF used for performance testing of various fluid-loss control additives for oil-based drill-in fluid.

TABLE 2
Composition of Oil-Based Reservoir Drill-in Fluid Used for
Performance Testing of Fluid-Loss Control Additives.

| | | | | 0.5 ppb | | |
|---|---|---|---|---|---|---|
| | | | | White Polymer, | 2 ppb | |
| | | 1 ppb | 0.5 ppb | (styrene | amine | |
| | | FLA-1 (on | FLA-1 (on | methacrylate | treated | Mixing |
| | | solids basis) | solids basis) | polymer) | lignite | Time |
| | Density | (grams) | (grams) | (grams) | (grams) | (min) |
| Diesel Oil - | 0.86 | 168.61 | 168.87 | 168.87 | 168.61 | 1 |
| Low Sulfur | | | | | | |
| Primary | 0.99 | 4.00 | 4.00 | 4.00 | 4.00 | 1 |
| Emulsifier | | | | | | |
| (maleated tall | | | | | | |
| oil) | | | | | | |
| Lime | 2.23 | 3.00 | 3.00 | 3.00 | 3.00 | 1 |
| Fluid Loss | | | | 0.50 | 2.00 | 1 |
| Additive Active | | | | | | |
| Amount | | | | | | |
| Amount of | | 2.86 | 1.43 | | | 1 |
| FLA1 @ 35% | | | | | | |
| w/w added | | | | | | |
| Secondary | 0.95 | 2.00 | 2.00 | 2.00 | 2.00 | 1 |
| Emulsifier | | | | | | |
| (carboxylic acid | | | | | | |
| terminated fatty | | | | | | |
| amine | | | | | | |
| condensate) | | | | | | |
| CaCl₂, 25% | 1.24 | | | 131.04 | 130.91 | 1 |
| w/w | | | | | | |
| Water added | | 96.32 | 97.35 | | | |
| for 25% w/w | | | | | | |
| CaCl₂ | | | | | | |
| CaCl₂ powder | | 32.73 | 32.76 | | | 13 |
| added for 25%, | | | | | | |
| w/w CaCl₂ | | | | | | |
| Claytone II | 1.60 | 2.00 | 2.00 | 2.00 | 2.00 | 4 |
| (organoclay) | | | | | | |
| Rev Dust | 2.50 | 20.00 | 20.00 | 20.00 | 20.00 | 10 |
| Sized CaCO₃, | 2.71 | 82.70 | 83.41 | 83.41 | 82.70 | 10 |
| D50 - 44 | | | | | | |
| microns | | | | | | |
| Total Weight | | 414.22 | 414.82 | 414.82 | 415.22 | |
| Mud Weight | | 9.9 | 9.9 | 9.9 | 9.9 | |
| Oil to Water | | 65/35 | 65/35 | 65/35 | 65/35 | |
| Ratio | | | | | | |

The oil-based RDF was prepared by sequentially adding the ingredients listed in Table 2 and mixing for the indicated time. After preparing the oil-based RDF, the RDF was then hot rolled at 150° F. for 16 hours. The fluid was then remixed on a multi-mixer for 15 minutes. The rheological properties of the oil-based RDF were examined, and ES was examined at 120° F. High Temperature High Pressure Fluid Loss (HTHP FL) test was run at 325° F., 500 psi. The rheological properties, ES and the HTHP filtration were examined according to the methods described in API Recommended Practice 13B-2, Fourth Edition, Recommended Practice for Field Testing of Oil-based Drilling Fluids.

### Example 2.2: Fluid-Loss Performance Test

Four samples of oil-based RDF were prepared according to the composition shown in Table 2 with different materials utilized to test for their fluid loss performance. “Control” samples of oil-based RDFs were prepared that contained styrene methacrylate polymer, a commercial white polymer, and amine treated lignite, a commercial black powder as the fluid-loss control additive. All of these fluids were subjected to high temperature high pressure fluid loss tests according to the test method set by API using a static filter press. A summary of fluid-loss performances of these oil-based RDF is provided in Table 3 below.

TABLE 3
Fluid-Loss Testing Results

| | | | 0.5 ppb White | 2 ppb Amine |
|---|---|---|---|---|
| | 1 ppb of FLA-1 | 0.5 of FLA-1 | Polymer | Treated-Lignite |
| | (grams) | (grams) | (grams) | (grams) |
| 600 RPM Dial | 38.1 | 40.1 | 45.9 | 39.9 |
| Reading @ 120° F. | | | | |
| 300 RPM Dial | 21.8 | 23.2 | 26.6 | 23.3 |
| Reading @ 120° F. | | | | |
| 200 RPM Dial | 15.9 | 17.3 | 19.5 | 17.5 |
| Reading @ 120° F. | | | | |
| 100 RPM Dial | 9.7 | 10.7 | 12.3 | 11.1 |
| Reading @ 120° F. | | | | |
| 6 RPM Dial | 2.2 | 3.1 | 3.6 | 3.4 |
| Reading @ 120° F. | | | | |
| 3 RPM Dial | 1.9 | 2.7 | 3 | 2.8 |
| Reading @ 120° F. | | | | |
| PV @ 120° F. | 16.3 | 16.9 | 19.3 | 16.6 |
| YP @ 120° F. | 5.5 | 6.3 | 7.3 | 6.7 |
| Gels 10 sec @ 120° F. | 2 | 3 | 4 | 4 |
| Gels 10 min @ 120° F. | 3 | 4 | 5 | 5 |
| ES @ 120° F. | 220 | 210 | 204 | 194 |
| HTHP FL 500 psi @ | 6.0 | 7.2 | 8.0 | 15.6 |
| 325° F. on API Filter | | | | |
| paper 2.5 inch | | | | |
| diameter, 2.7 μm | | | | |
| HTHP FL water 500 | 0.8 | 0.4 | 2 | 5 |
| psi @ 325° F. | | | | |

The exemplary fluid-loss additive FLA-1 is an approximately 35% w/w aqueous solution of the lignin derivative and is therefore water soluble. Exemplary fluid-loss additive FLA-1 was used at the active concentrations of 0.5 ppb and 1 ppb, and at both these concentrations the fluid loss of the oil-based RDF at 325° F. was controlled at 6.0 mL (0.8 mL H₂O) and 7.2 mL (0.4 mL H₂O) respectively. A fluid loss of less than 10 ml with no water in the filtrate is desired. Similarly, the commercially available white polymer at 0.5 ppb and the organo-lignite at 2 ppb were tested in this formulation, resulting in a fluid loss of 8.0 mL (2.0 mL H₂O) and 15.6 mL (5.0 mL H₂O), respectively. While the white polymer gave comparative fluid loss to the exemplary fluid-loss additive of the present disclosure, the water in the filtrate was approximately double that of the white polymer. The organo-lignite even at 2 ppb could not give controlled fluid loss of less than 10 ml. The volume of the fluid loss is generally directly proportional to the thickness of the filtrate cake. Thus, the lower the fluid loss, the thinner the filter cake.

Thus, the results demonstrate that the fluid-loss additive of the present disclosure will be more efficient at controlling the fluid loss of oil-based RDF than commercially available fluid-loss additives, and will deliver a thin filter cake with minimum filtrate and solid fines invasion to the formation.

### Example 3: Fluid-Loss Performance Testing in a Mineral Oil-Based Reservoir Drill-in Fluid

### Example 3.1: Preparation of Mineral Oil-Based Drill-in Fluids

### Table 2: Composition of Oil-Based Reservoir Drill-in Fluid Used for Performance Testing of Fluid-Loss Control Additives.

Several mineral oil-based reservoir drill-in fluids RDF were prepared according to the compositions shown in Table 4, with the exception that they used different materials as fluid-loss control additives to compare exemplary additives of the present disclosure with commercially available styrene methacrylate white polymer and amine treated lignite. Thus, Table 4 below shows representative composition of the mineral oil-based RDF used for performance testing of various fluid-loss control additives for oil-based drill-in fluid. The formulations are based on Table 1 of SPE-163357 (M. A. Zubail, et al. Improved Producibility after Delayed Filter Cake Breaker Treatment in the Safaniya Offshore Field in Saudi Arabia. SPE-163357 Society of Petroleum Engineers International Conference and Exhibition December 2012), except that a lower dose of organoclay (8 ppb) was utilized and lower doses of the fluid-loss additive of the present disclosure and several commercially available fluid-loss additives were compared.

TABLE 4
Composition of Mineral Oil-Based Reservoir Drill-in Fluid Used
for Performance Testing of Fluid-Loss Control Additives.

| | | FLA-4 @ | FLA-4 @ | | | |
|---|---|---|---|---|---|---|
| | | 36.45% | 36.45% | Amine | Styrene | |
| | | w/w | w/w | Treated | Methacrylate | |
| | | (Fluid 1) | (Fluid 2) | Lignite | Polymer | Mix |
| | S.G. | gm | gm | gm | gm | min |
| Mineral oil, LVT 200 | 0.82 | 160.70 | 160.02 | 160.54 | 160.78 | |
| Envamul 600 | 0.99 | 11.00 | 11.00 | 11.00 | 11.00 | 1.00 |
| Lime | 2.23 | 4.00 | 4.00 | 4.00 | 4.00 | 1.00 |
| FLA | | 1.00 | 3.00 | 3.00 | 0.50 | 1.00 |
| Actual amount FLA-4 added | | 2.74 | 8.23 | | | |
| CaCl₂ 30% w/w | 1.30 | | | 109.08 | 109.24 | 10.00 |
| Water added | | 74.69 | 70.87 | | | |
| CaCl₂ powder added | | 32.76 | 32.62 | | | |
| Envamul 1884 | 0.95 | 4.00 | 4.00 | 4.00 | 4.00 | 1.00 |
| Claytone II | 1.60 | 8.00 | 8.00 | 8.00 | 8.00 | 10.00 |
| Sized ground marble, D50 = | 2.71 | 85.63 | 85.06 | 84.47 | 85.89 | 3.00 |
| 5 micron | | | | | | |
| Sized ground marble, D50 = | 2.71 | 42.18 | 41.90 | 41.61 | 42.30 | 3.00 |
| 25 micron | | | | | | |

| | | | | | |
|---|---|---|---|---|---|
| Wt. | 425.70 | 425.70 | 425.70 | 425.71 | 30.00 |
| Actual Mud | 10.15 | 10.15 | 10.15 | 10.15 | |
| OWR | 70/30 | 70/30 | 70/30 | 70/30 | |

Hot roll @ 150 F. for 16 hours

### Example 3.2: Fluid-Loss Performance Test

Three samples of mineral oil-based RDF were prepared according to Table 4 with different materials utilized to test for their fluid loss performance. “Control” samples of oil-based RDFs were prepared that contained styrene methacrylate polymer, a commercial white polymer, and amine treated lignite, a commercial black powder as the fluid-loss control additive. Each of the fluids were subjected to high temperature high pressure fluid loss tests according to the test method set by API using a static filter press with an API filter initially. Then, a fresh fluid formulated with FLA-4 and conditioned similarly as gien in Table 4 was tested on API designated 20 micron and 50 micron ceramic filter disk fitted to a double ended HPHT cell. See, e.g., FIG. 1 of U.S. Pat. No. 7,906,464. A summary of performances of these mineral oil-based RDF is provided in Table 5 below.

TABLE 5
Fluid-loss testing results

| | FLA-4 @ | FLA-4 @ | Amine | Styrene |
|---|---|---|---|---|
| | 36.45% w/w | 36.45% w/w | Treated | Methacrylate |
| | (Fluid 1) | (Fluid 2) | Lignite | Polymer |
| D. R for 600 RPM @ 150 F. | 69.8 | 68.4 | 71.7 | 77.6 |
| D. R for 300 RPM @ 150 F. | 40.3 | 39.2 | 40.3 | 45.2 |
| D. R for 200 RPM @ 150 F. | 29.7 | 28.9 | 29.2 | 33.7 |
| D. R for 100 RPM @ 150 F. | 18.3 | 17.8 | 17.3 | 21.1 |
| D. R for 6 RPM @ 150 F. | 5.2 | 4.8 | 4.1 | 6.3 |
| D. R for 3 RPM @ 150 F. | 4 | 3.9 | 3.2 | 5.2 |
| PV | 29.5 | 29.2 | 31.4 | 32.4 |
| YP | 10.8 | 10 | 8.9 | 12.8 |
| Gels 10 sec | 5 | 4 | 4 | 6 |
| Gels 10 min | 6 | 5 | 5 | 8 |
| ES at 150° F. | 235 | 343 | 172 | 253 |
| Cake of 32 | 1 | 1 | 1 | 1 |
| HTHP 500 psi @ 150° F. (<10.0) | 0.1 × 2 = 0.2 | 0.2 × 2 = 0.4 | 0.2 × 2 = 0.4 | 0.1 × 2 = 0.2 |
| on API Filter paper 2.5 inch | | | | |
| diameter, 2.7 μm, 30 minutes | | | | |
| Water | 0 | 0 | 0 | 0 |
| Cake thickness of 32 on ceramic | 1 | <4 | | |
| filter disk | | | | |
| HTHP 500 psi @ 150° F. (<10.0) | <1 ml | <1 ml | | |
| on API designated 20 & 50 | | | | |
| micron ceramic filter disk, 30 | | | | |
| minutes | | | | |

### Example 3 Filter Cake Cleanup of Oil-Based Reservoir Drill-in Fluid Formulated with Fluid-Loss Additive of the Present Disclosure

Filter cake breaker fluid test (the “oven test”) can be performed as outlined in SPE-163357 on pages 4-5 with the breaker formulation of Table 2 of SPE-163357 (0.73 bbl NaCl Brine 68 PCF, 1.6 ppb sodium bicarbonate, 5% V/V mutual solvent, 2% V/V water wetting additive, and 20% V/V delayed filter cake breaker). The testing conditions and ceramic disk pore throat diameter are chosen based on well conditions and/or well requirements.

These procedures allow one to determine the cleanability of the filter cake with a particular breaker fluid through visual observation of the ceramic/aloxite disk. See, e.g., SPE-163357 and U.S. Pat. No. 7,906,464. Alternatively, the cleanability of the filter cake can be determined by examining the water injectivity of the fresh ceramic disk before the filter cake deposition and after the filter cake clean up. See, e.g., SPE-163357. An oil-based RDF that produces an easily cleanable filter cake will have a water injectivity after filter cake cleanup that is similar to a fresh ceramic disk. Furthermore, the cleanability of the filter cake can be determined by comparing the weights of the fresh ceramic disk, the ceramic disk with the filter cake, and the ceramic disk after the filter cake cleanup is performed. See, e.g., SPE-177982. The weight of the ceramic disk after filter cake cleanup will be similar to a fresh ceramic disk with an oil-based RDF that produces an easily cleanable filter cake. This is also referred to as removal efficiency.

Next, a formation response or core flooding test is performed. This test determines the lift off pressure of the filter cake. An oil-based RDF that produces an easily cleanable filter cake will have a low the lift off pressure of the filter cake.

Regain permeability percent is the ratio of the permeability of the core for the oil after exposure to oil-based RDF and filter cake clean up (numerator) to the initial permeability of the fresh core for the oil (Ko) (denominator). An oil-based RDF that produces an easily cleanable filter cake will have a high regain permeability percent (i.e., closer to 100%).

One of the components used to make the exemplary fluid-loss additive of the present disclosure described above (FLA-1) is Reax 85A, a sulfomethylated lignin. It is believed that the reaction product/blend of Reax 85A and PC-2144 (a fatty imidazoline as described above) is likely a highly aggregated lignin derivative. As shown in FIG. 2 (reproduced from Konduri and Fatehil. ACS Sustainable Chem. Eng. 2015, 3, 1172-1182), Konduri and Fatehil showed that sulfomethylated lignin is fully soluble in water and at a pH of 4 and 3 it is 60% and 20% soluble respectively. The sulfomethylated lignin is insoluble at pH 2.

Thus, the filter cake formed with oil-based RDF and formulated with the exemplary fluid-loss additive of the present disclosure of the examples should be easily cleanable with appropriately designed breaker solutions for oil-based filter cake. The active component of the exemplary oil-based RDF fluid-loss additive of the examples at 1 ppb is roughly 1% of the total solids (Rev Dust and CaCO₃) present in the oil-based RDF, thus without wishing to be found by any particular theory, the lignin derivative should constitute roughly 1% of the filter cake. The different typical breaker solutions that can be used to clean the filter cake that results from an oil-based RDF formulated with the oil-based RDF fluid-loss additive of the present disclosure of the examples include: (1) a breaker solution composed of mutual solvent, water wetting surfactant and an organic acid with pH in range of 3-4 should easily clean the filter cake of the oil-based RDF composed of the lignin derivative. (Reference SPE-163357, as an example for an acid-based breaker solution application for oil-based RDF), (2) a breaker solution with complexing agents like Nitrilotriacetic acid (NTA) and Ethylene diamine-tetra-acetic acid (EDTA), a mutual solvent and a water wetting surfactant, with pH from 4-13, can easily clean the filter cake. (Reference SPE-177982-MS, an example of a complexing agent-based breaker solution for oil-based RDF), and (3) alternatively, if the oil-based RDF is formulated with a combination of barite (not preferred since it is acid (HCl) insoluble but may be added for increased density) and CaCO₃, complexing agents like EDTA and diethylenetriaminepentaacetic acid (DTPA) can be added to remove the filter cake in typical pH of 3.6-13. (Reference SPE-1993014, as an example of a complexing agent-based breaker solution for barite).

Breaker Fluid Oven Test. The test simulates placement of the breaker fluid and “immediate” isolation of the reservoir from overbalance. Reservoir temperature and shut in period are replicated. The oil-based RDF of Table 4 were examined with the breaker fluid oven test with the results shown below in Table 6.

Ceramic disc was pre-soaked in the base fluid of the oil-based RDF being tested for at least 30 minutes. The ceramic disc was then placed in a double-ended HPHT cell. The cell was filled with 250 ml) of water, and then 100 psi of pressure was applied to the inlet valve stem and then this stem was closed. The bottom valve stem remained closed during this time. The cell was then brought to 150° F. To determine the initial injectivity for water, the bottom valve of the double-ended HPHT cell was then opened to determine the time required for the water to flow out of the cell through the ceramic disk. The cell was then filled with 350 ml of oil-based RDF and placed in a heated jacket at a desired temperature (e.g., a reservoir temperature). Pressure was applied at 500 psi differential. Fluid loss from the bottom valve stem was measured during filter cake formation. After the filter cake build up for the given time, the cell was depressurized and the excess mud was poured from the cell while maintain the filter cake intact. With a closed bottom stem, the filter cake breaker fluid was poured into the cell through the side of the cell wall to avoid damaging the filter cake. The cell was pressurized to an appropriate pressure (such as, 100 psi), sealed and placed in a heated jacket or oven at the desired temperature for a specified number of hours (typically 16 or 24 to 48 hours). Once the incubation was complete, the cell was removed from the heated jacket or oven and allowed to cool. The cell was then opened and its content (i.e, the used filter cake breaker fluid and filter cake debris) carefully removed to not disturb the ceramic disk.

The final injectivity was determined in the same fashion as the initial injectivity (i.e., determined the time it takes for 250 grams of water to pass with 100 psi applied to the inlet valve, the inlet valve stem remaining closed during the water injectivity determination). The weight of the ceramic disk was recorded at the following steps: after soaking in the base oil which gives the initial weight of the ceramic disk (W₁), after filter cake formation with the filter cake on the ceramic disk (W₂), and after final water injectivity test with the remaining filter cake residue on the ceramic disk (W₃). The filter case clean-up or removal efficiency % was calculated with the following formula:

$$100 \times \frac{{W}_{3} - {W}_{1}}{{W}_{2} - {W}_{1}} .$$

A summary of how the exemplary fluids performed in the oven test are shown below in Table 6. As can be seen by comparing the initial water injectivity, the final water injectivity, and the filter cake removal efficiency of the exemplary fluids, exemplary fluids of the present disclosure produce filter cakes that are easily cleanable.

TABLE 6
Breaker fluid oven test results

| | | | |
|---|---|---|---|
| | FLA-4 @ | FLA-4 @ | FLA-4 @ |
| | 36.45% w/w | 36.45% w/w | 36.45% w/w |
| | (Fluid 1) after | (Fluid 2) after | (Fluid 2) after |
| | hot roll @ | hot roll @ | hot roll @ |
| Specific | 150° F. for 16 | 150° F. for 16 | 150° F. for 16 |
| gravity | hours | hours | hours |

| | | | |
|---|---|---|---|
| API designated micron ceramic filter | 20 micron | 50 micron | 50 micron |
| disk type | | | |
| HPHT Fluid loss @ 150° F. & 500 psi | 0.2 | 0.2 | 0.3 |
| after 6 hours - ml | | | |
| Cake thickness of 32 on ceramic filter | 4 | 4 | 3 |
| disk | | | |

Filter cake breaker fluid formulation

| | | | | |
|---|---|---|---|---|
| Brine type and aqueous percentage | | 16% w/w NaCl | 14% w/w NaBr | 14% w/w NaBr |
| Brine % v/v | 1.12 | 88.0% | 88.0% | 86.0% |
| Mutual solvent, ethylene glycol | 0.90 | 5.0% | 5.0% | 5.0% |
| monobutyl ether % v/v | | | | |
| Breaker acid, Formic acid % v/v | 1.23 | 5.0% | 5.0% | 7.0% |
| Water wetting surfactant, Amphosol LB | 1.04 | 2.0% | 2.0% | 2.0% |
| % v/v | | | | |
| Total Volume of Breaker fluid - ml | | 250 | 250 | 250 |
| Density of breaker fluid - ppg | | 9.3 | 9.3 | 9.3 |

Oven test results for filter cake clean-up

| | | | |
|---|---|---|---|
| Filter cake soaking time with breaker | 16 | 16 | 16 |
| fluid - hours | | | |
| Initial water Injectivity of ceramic disk | 16 | 16 | 15 |
| for 250 ml water @ 150° F. & 100 | | | |
| psi - secs | | | |
| Final water Injectivity of ceramic disk | 16 | 18 | 20 |
| for 250 ml water @ 150° F. & 100 | | | |
| psi - secs | | | |
| Removal Efficiency or Filter cake clean | 100 | 97 | 93 |
| up on the ceramic disk in % w/w | | | |
| after the water Injectivity test | | | |

Leak Off and Regain Permeability Examination. Two core plugs are examined simultaneously and received the same treatments, except that the mud breaker clean up step was only applied to one of the core plugs (this is described in greater detail below). Core plugs were extracted of hydrocarbons, leached of salts, and dried until the weight stabilized. Basic properties including grain density, pore volume, and permeability to air were measured at 800 and 1500 psi net confining stress.

Synthetic formation brine (3% KCl) was prepared based on the provided analysis using deionized water and reagent grade chemicals. The brine was filtered to 0.45 microns and degassed. Fluid parameters including viscosity and density were measured at ambient temperature. Selected core plug samples were evacuated of air and pressure-saturated with synthetic formation brine. The samples were loaded into an air displacing brine centrifuge and spun to initial water saturation at 200 psi capillary pressure.

The samples were unloaded from the centrifuge and briefly vacuum saturated with lab oil (isopar). Each sample was loaded in a hydrostatic core holder inside an air bath oven with a ⅛″ thick spacer ring installed on the injection face of the sample to allow for the circulation of oil-based RDF. Fifteen-hundred psi net confining stress was applied, and 200 psi pore pressure was established by passing isopar lab oil through the system and around the sample. Sample and system were elevated to 150° F. while maintaining net confining stress and pore pressure. The initial permeability of the core plugs was determined with the Isopar.

Oil-based RDF was circulated across the injection face of the sample at the calculated overbalance pressure of 300 psi for an appropriate period of time (such as, 4 hours). Leakoff volume as a function of time was recorded. The Sample was statically locked in for a determined period of times, such as 4 to 48 hours (e.g., 4 hours, 12 hours, 18 hours, 24 hours, 30 hours, 36 hours, 42 hours, or 48 hours).

Isopar oil was then re-injected in the production flow direction at an initial low constant rate while monitoring the pressure. Liftoff pressure was determined.

Isopar oil was injected through the core plug at a constant rate in the production direction while monitoring differential pressure. Regain effective permeability to oil at residual fluid saturation was determined at three rates (e.g., three rates in the range of 1 ml/min to 7 ml/min).

The filter cake breaker fluid is then injected through the system at a low constant rate for 0-4 hours to flush excess drilling mud out of the system and then static soaking with filter cake breaker fluid for 4 to 48 hours, while the other core plug did not have a mud breaker fluid clean up step.

Isopar oil was injected through the core plug at a constant rate in the production direction while monitoring differential pressure. Regain effective permeability to oil at residual fluid saturation was determined at three rates (e.g., three rates in the range of 1 ml/min to 7 ml/min).

Coreholder, sample, and system were cooled to ambient temperature while by passing isopar lab oil through the system and around the sample. Pore pressure and net confining stress were slowly removed. Each sample was unloaded from the hydrostatic coreholder. The mud cake was carefully removed from the injection face of each sample, placed in a sample bag, labeled, and inventoried.

Permeability to liquid versus throughput data, and leakoff versus time were calculated from the experimental data and measured sample and fluid parameters using Darcy's law.

### Example 4—Improved Suspension and Rheological Properties of Oil-Based Reservoir Drill-in Fluids Formulated with an Exemplary Fluid-Loss Additive of the Present Disclosure

The suspension and rheological properties of the oil-based RDFs was determined after the fluid was static heat aged for three days at the given temperature (325° F. for 18 ppg) as per the following steps.

First, the formulated fluid was mixed on the multimixer for 10 minutes, transferred to the aging cell and pressurized at 400 psi with nitrogen. The cell was placed in an upright position for static heat aging in the oven for desired temperature and duration.

After static aging, the top oil separation was determined in volume units with a measuring cylinder and reported as a percentage of the total volume of the fluid. Only the fluids with top oil separation of ≤10% were considered for further analysis.

Next, the suspension performance was assessed via its sag factor. Sag is defined as the phenomenon by which a wellbore fluid comprising a weighting agent fails to fully suspend every part of the weighting agent suspended in the wellbore fluid medium. It manifests as a precipitation of the weighting agent solid from the wellbore fluid medium. To calculate the sag factor, the fluid column in the aging cell was roughly divided into three portions and the first two portions were removed with a syringe. The specific gravity of the bottom (SG bottom) portion of the fluid (the last or third portion of the fluid) in the aging cell was determined by drawing 10 ml volume with a syringe and measuring its weights on an analytical balance. The sag factor was calculated using the following equation, from Omland et al. (Omland, T. H., et al. Weighting Material Sag. Annual Transactions of the Nordic Rheology Society, Vol. 12, 2004):

$$Sag Factor = \frac{{SG}_{bottom}}{2 ⨯ {SG}_{initial}} .$$

A sag factor greater than 0.53 implies that the fluid has the potential to sag. After the sag factor determination, the fluid was mixed on the multimixer for five minutes and its rheological properties, ES and HPHT fluid loss were tested.

The oil-based RDF formulations that were prepared and tested are shown in Table 7 below.

TABLE 7
Composition of Oil-Based Reservoir Drill-in Fluid Used for
Performance Testing of Fluid-Loss Control Additives.

| | | Ex. No. | | | | | | |
|---|---|---|---|---|---|---|---|---|
| | | RDF-1 | RDF-2 | RDF-3 | RDF-4 | RDF-5 | RDF-6 | |
| | | Description | | | | | | |
| | | FLA-2 @ | FLA-3 @ | FLA-2 @ | FLA-3 @ | White | White | |
| | | 41.35% | 48.2% | 41.63% | 48.2% | Polymer | Polymer | |
| Mud | Density | ppb | ppb | ppb | ppb | ppb | ppb | Mixing |
| Components | (g/ml) | (g) | (g) | (g) | (g) | (g) | (g) | Time |
| Escaid 110 | 0.79 | 136.27 | 137.27 | 123.08 | 123.08 | 124.01 | 137.24 | |
| Envamul | 0.99 | 1.00 | 1.00 | 1.00 | 1.00 | 1.00 | 1.00 | 1 min |
| 2157 | | | | | | | | |
| Envamul | 0.94 | 13.00 | 13.00 | 13.00 | 13.00 | 13.00 | 13.00 | 1 min |
| 1884 | | | | | | | | |
| Lime | 2.50 | 4.00 | 4.00 | 4.00 | 4.00 | 4.00 | 4.00 | 1 min |
| White | 1.03 | | | | | 2.00 | 2.00 | 1 min |
| Polymer | | | | | | | | |
| Amount of | 1.33 | 12.09 | 10.37 | 12.01 | 10.37 | | | 1 min |
| Ex. FLA | | | | | | | | |
| CaCl₂ | | 11.87 | 11.87 | 10.72 | 10.72 | 10.80 | 11.96 | 10 mins |
| powder | | | | | | | | |
| added for | | | | | | | | |
| 30%, w/w | | | | | | | | |
| CaCl₂ | | | | | | | | |
| Water added | | 20.61 | 22.33 | 18.01 | 19.64 | 25.21 | 27.90 | |
| for 30% w/w | | | | | | | | |
| CaCl₂ | | | | | | | | |
| Bentone 920 | | 5.50 | 5.50 | 5.50 | 5.50 | 5.50 | 5.50 | 15 min |
| Micronized | | 537.10 | 537.10 | | | | 538.85 | 10 min |
| limenite | | | | | | | | |
| Barite | | | | 554.12 | 554.12 | 555.93 | | 10 min |
| Envamod 595 | | 3.50 | 3.50 | 3.50 | 3.50 | 3.50 | 3.50 | 5 min |
| Rev Dust | | 10.00 | 10.00 | 10.00 | 10.00 | 10.00 | 10.00 | 5 min |
| Total Weight | | 754.9 | 754.9 | 754.9 | 754.9 | 755.0 | 754.9 | |
| Volume | | 349.99 | 349.99 | 350.00 | 350.00 | 3.50.01 | 350.00 | |
| Actual Mud | | 18.00 | 18.00 | 18.00 | 18.00 | 18.00 | 18.00 | |
| Weight | | | | | | | | |
| Oil to Water | | 0.85 | 0.85 | 0.85 | 0.85 | 0.85 | 0.85 | |
| Ratio | | | | | | | | |

The rheological properties of the oil-based RDF of Table 4 are in Table 8 below. For comparison the oil-based RDF were formulated with different weighting agents—(micronized ilmenite and barite) and different fluid-loss additives (FLA-2 and FLA-3 dosed at 5 ppb, and styrene methacrylate white polymer dosed at 2 ppb). The white polymer was dosed only up to 2 ppb, since at higher dosages, it drastically increases the rheological properties of the oil-based RDF. In the analysis below, the rheological properties were determined after a static hot age of 3 days was considered.

TABLE 8
Fluid-Loss Testing Results

| | Ex. No. | | | | | | | | | | | |
|---|---|---|---|---|---|---|---|---|---|---|---|---|
| | FLA-1 | | FLA-2 | | FLA-3 | | FLA-4 | | FLA-5 | | FLA-6 | |
| | Weighting Agent | | | | | | | | | | | |
| | Micronized | | Micronized | | | | | | | | Micronized | |
| | Ilmenite | | Ilmenite | | Barite | | Barite | | Barite | | Ilmenite | |
| | | ASHA- | | ASHA- | | ASHA- | | ASHA- | | ASHA- | | ASHA- |
| | | 3 day | | 3 day | | 3 day | | 3 day | | 3 day | | 3 day |
| | BSHA | 325° F. | BSHA | 325° F. | BSHA | 325° F. | BSHA | 325° F. | BSHA | 325° F. | BSHA | 325° F. |
| 600 RPM Dial | 94.0 | 98.6 | 92.6 | 102.1 | 135.2 | 125.0 | 152.3 | 134.5 | 170.3 | 161.4 | 127.3 | 109.7 |
| Reading @ | | | | | | | | | | | | |
| 150° F. (DR) | | | | | | | | | | | | |
| 300 RPM Dial | 61.8 | 61.7 | 61.1 | 63.3 | 86.2 | 75.1 | 94.7 | 80.1 | 102.0 | 93.7 | 83.1 | 65.8 |
| Reading @ | | | | | | | | | | | | |
| 150° F. (DR) | | | | | | | | | | | | |
| 200 RPM Dial | 50.6 | 48.6 | 50.0 | 49.8 | 68.9 | 57.2 | 75.8 | 60.7 | 80.9 | 70.3 | 67.2 | 50.6 |
| Reading @ | | | | | | | | | | | | |
| 150° F. (DR) | | | | | | | | | | | | |
| 100 RPM Dial | 38.2 | 34.4 | 37.6 | 34.9 | 49.2 | 37.3 | 53.8 | 40.0 | 56.9 | 45.2 | 49.7 | 34.3 |
| Reading @ | | | | | | | | | | | | |
| 150° F. (DR) | | | | | | | | | | | | |
| 6 RPM Dial | 23.3 | 16.7 | 23.3 | 16.8 | 25.3 | 13.9 | 26.4 | 14.7 | 29.0 | 16.3 | 28.7 | 15.3 |
| Reading @ | | | | | | | | | | | | |
| 150° F. (DR) | | | | | | | | | | | | |
| 3 RPM Dial | 22.7 | 15.7 | 22.7 | 15.2 | 25.0 | 12.6 | 25.5 | 13.6 | 20.3 | 14.8 | 27.1 | 14.1 |
| Reading @ | | | | | | | | | | | | |
| 150° F. (DR) | | | | | | | | | | | | |
| PV @ 150° F. (cP) | 32.2 | 36.9 | 31.5 | 38.8 | 49.0 | 49.9 | 57.6 | 54.4 | 68.3 | 67.7 | 44.2 | 43.9 |
| YP @ 150° F. | 29.6 | 24.8 | 29.6 | 24.5 | 37.2 | 25.2 | 37.1 | 25.7 | 33.7 | 26.0 | 38.9 | 21.9 |
| (lb/100 ft²)) | | | | | | | | | | | | |
| LSYP @ 150° F. | 22.1 | 14.7 | 22.1 | 13.5 | 24.7 | 11.3 | 24.5 | 12.5 | 11.6 | 13.3 | 25.5 | 12.9 |
| Gels 10 sec @ | 30.0 | 18.0 | 29.0 | 19.0 | 29.0 | 14.0 | 30.0 | 16.0 | 33.0 | 19.0 | 37.0 | 17.0 |
| 150° F. (DR) | | | | | | | | | | | | |
| Gels 10 min @ | 39.0 | 27.0 | 38.0 | 30.0 | 42.0 | 24.0 | 42.0 | 18.0 | 46.0 | 32.0 | 45.0 | 26.0 |
| 150° F. (DR) | | | | | | | | | | | | |
| ES @ | 591 | 788 | 626 | 799 | 1643 | 1430 | 1570 | 1368 | 1685 | 1070 | 710 | 726 |
| 150° F. (V) | | | | | | | | | | | | |
| HTHP FL 500 psi @ | | 6.0 | | 4.2 | | 1.0 | | 3.2 | | 1.0 | | 35.0 |
| 325° F. (ml) on | | | | | | | | | | | | |
| API filter paper | | | | | | | | | | | | |
| 2.5 inch diameter, | | | | | | | | | | | | |
| 2.7 micron | | | | | | | | | | | | |
| Supernatant | | 34.0 | | 33.0 | | 28.0 | | 23.0 | | 18.0 | | 35.0 |
| Liquid (ml) | | | | | | | | | | | | |
| Initial (g/ml)) | | 2.161 | | 2.161 | | 2.161 | | 2.161 | | 2.161 | | 2.161 |
| Density-Bottom | | 2.278 | | 2.2377 | | 2.344 | | 2.2748 | | 2.344 | | 2.3036 |
| (g/ml) | | | | | | | | | | | | |
| Sag | | 0.527 | | 0.518 | | 0.542 | | 0.526 | | 0.542 | | 0.533 |

Exemplary oil-based RDF-1 and exemplary oil-based RDF-2 were formulated with micronized ilmenite and two exemplary fluid-loss additives of the present disclosure (FLA-2 and FLA-3). RDF-1 and RDF-2 had similar overall rheological properties. For example, the plastic viscosity (PV) in cP and yield point (YP) in lb/100 ft² of RDF-1 and RDF-2 were 36.9 & 38.8 and 24.8 & 24.5, respectively. However, RDF-1 has a sag factor of 0.527 and RDF-2 had a sag factor 0.518. This improvement in sag factor from RDF-1 to RDF-2 is attributed to increase in product activity of the exemplary fluid-loss additive from 41.35% w/w for FLA-2 to 48.2% w/w for FLA-3.

Exemplary oil-based RDF-3 and exemplary oil-based RDF-4 were formulated with API barite and two different exemplary fluid-loss additives of the present disclosure (FLA-2 and FLA-3). The PV of RDF-3 was 49.9 and that of RDF-4 was 9% higher at 54.6. The yield point of the exemplary fluids were between 25 and 26. The sag factor of exemplary fluid 6 was 0.542 and the sag factor for RDF-4 was 0.526. Again, the improvement in sag factor from RDF-3 to RDF-4 is attributed to the increase in product activity from 41.35% w/w for FLA-2 to 48.2% w/w for FLA-3.

Overall, RDF-5 (formulated with barite and white polymer) had higher rheological properties as compared with RDF-4 (formulated with barite and FLA-3). The PV of RDF-5 was 67.7, roughly 36% higher than PV of RDF-4 at 49.9. The YP of RDF-5 and RDF-4 was similar, between 25 and 26. The 10 min gel strength in lb/100 ft² of RDF-5 was 32, while RDF-4 was eighteen. The sag factor of RDF-5 was 0.542 as compared to RDF-4 at 0.526. These results demonstrate that higher gel strength did not govern the suspension of the weighting agent in these fluids. The results show that the exemplary fluid-loss additives of the present disclosure deliver improved suspension character to the RDF without adversely affecting or increasing the rheological properties of the RDF.

RDF-6 (formulated with barite and white polymer) exhibited higher rheological properties as compared to RDF-1 (formulated with barite and FLA-2). For example, the PV of exemplary fluid 8 was 43.9, roughly 19% higher than PV of RDF-1 at 36.9. The YP of RDF-6 and RDF-1 were 21.9 and 24.8, approximately 11% difference. The 10 min gel strength of RDF-8 and RDF-1 were similar, between 26 and 27. The sag factor of RDF-5 was 0.533 (desired specification ≤0.53) as compared to RDF-1 at 0.527. Again, the results show that exemplary oil-based RDF fluid-loss additives of the present disclosure deliver improved suspension character to the RDF without adversely affecting or increasing the rheological properties of the RDF.

Thus, increasing the product activity of exemplary fluid-loss additive delivers improved suspension in oil-based RDFs formulated with different weighting agents. It is believe that higher product activity leads to larger aggregates being formed in the exemplary fluid-loss additives of the present disclosure, which may deliver improved suspension to the oil-based RDFs. The exemplary fluid-loss additives delivered an oil-based RDF with lower rheological properties and improved suspension as compared to the commercially available fluid-loss additives, like styrene methacrylate white polymer. Since the exemplary fluid-loss additives deliver RDFs with lower rheological properties and improved suspension, the fluid-loss additives of the present disclosure will exhibit lower friction pressure as compared to oil-based RDFs similarly formulated with commercially available fluid-loss additives. Thus, oil-based RDFs formulated with the oil-based RDF fluid-loss additive of the present disclosure will deliver low ECD fluid to drill wellbores with narrow drilling windows.

### Example 5: Flow Point and Gel Point Examination in Oil-Based Reservoir Drill-in Fluids Formulated with Examination Fluid-Loss Additives of the Present Disclosure

The oscillatory amplitude sweep test was performed on an Anton Paar MCR 302 rheometer at 150° F. with a parallel plate geometry—PP50 and a zero gap of 1 mm. RDF samples were preconditioned by pre-shearing for five minutes at 1000 s₋₁ followed by a rest stage of 10 minutes for microstructure growth. Then an oscillatory amplitude sweep was performed with a series of oscillations at constant frequency of 10 rad/sec and varying strain amplitude (γ) from 0.001%-100%. Under these conditions, the following were determined: (1) G′, storage modulus which denotes solid character; (2) G″, loss modulus which denotes the liquid character; (3) δ, phase angle, when closer to 0° denotes solid or elastic character, when closer to 900 denotes liquid or viscous character and when 450 it is sol-gel transition when material begins to flow; (4) flow point τ_{f}, is the shear stress at the crossover point of G′ and G″ also at the crossover the δ is 45°.

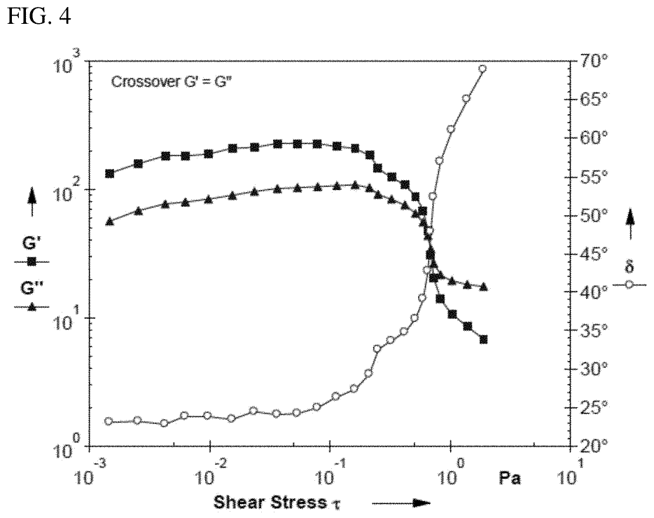

These material properties were compared for the different RDFs examined. The values in Pa units can be divided by 0.4788 to convert into units of lb/100 ft². FIG. 4 illustrates how the flow point τ_{f} is determined, the points plotted include the storage modulus in Pa (G′), the loss modulus in Pa (G″), and the phase angle (δ) as a function of the shear stress in Pa (τ). The moduli G′ and G″ are linear in the τ range from 0.001 Pa to 0.1 Pa, this is the linear viscoelastic region (LVER) of the fluid, and it indicates how large a strain the fluid tolerates before the internal structure of the fluid starts to break. In this region, the 6 is fairly constant and linear around 25°. Since in this range the G′ is greater than the G″, the fluid has solid character and is a gel. In the τ range from 0.1 Pa to 1 Pa, the G′ and G″ fall abruptly and the 6 rises abruptly from around 25°. The G′ and G″ crossover occurs and G″ is now greater than G′, and the fluid transitions from a gel to a liquid. The crossover of the G′ and G″ occurs at 6 of 45°. The τ at the crossover is the flow point, τ_{f}. The flow point, τ_{f}, represents flow transition from a gel to a liquid. The flow point is also referred to as the gel point.

The flow point of the RDF-3 and RDF-5 in Table 4 were determined by the oscillatory amplitude sweep test and are given in Table 6 below. The flow point of RDF-5 (formulated with white polymer) is 8.88 Pa, which is roughly 170% higher than the flow point of RDF-3 (formulated with the FLA-2) at 3.31 Pa. The results demonstrate that the RDF-3 requires much lower shear stress to start flowing than RDF-5. A fluid with a higher flow point will need a higher pump initiation pressure to break circulation after the RDF is in static condition for a period. A high pump pressure increases the probability of formation fracture (due to a high ECD experienced in the wellbore), thereby inducing fluid losses to the formation.

The flow point data again demonstrates that oil-based RDFs formulated with exemplary oil-based RDF fluid-loss additives of the present disclosure will deliver lower ECD, as compared to oil-based RDFs formulated with commercially available fluid-loss additives.

TABLE 6
Flow points of oil-based reservoir drill-in
fluids at 150° F. and ASHA of 3 days

| | RDF-6 | RDF-5 |
|---|---|---|
| Ex. No. | (barite & | (barite & |
| (description) | FLA-2 @ 41.63%) | white polymer) |
| Flow Point/Gel Point (τ_{f}), | 3.31 | 8.88 |
| Pa | | |
| Flow Point/Gel Point (τ_{f}), | 6.91 | 18.54 |
| lb/100 ft² | | |

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references or publication are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range. “Combinations” is inclusive of blends, mixtures, alloys, reaction products, and the like. The terms “first”, “second”, and the like, do not denote any order, quantity, or importance, but rather are used to denote one element from another.

The terms “fluid loss control additive” and “fluid loss additive” are used interchangeably and are synonymous for the purpose of this disclosure.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. An oil-based reservoir drill-in fluid (RDF) comprising an invert emulsion of a hygroscopic liquid, one or more weighting or bridging agent that includes a weighting or bridging agent, an oil-based RDF additive, and at least one of: an oil, mineral oil, synthetic oil (e.g., one or more of internal olefin, poly alpha olefin, and linear paraffin), or a combination thereof, wherein the oil-based RDF further comprises:
a blend, reaction product, or a mixture thereof, of:
one or more hydrophobizing component or agent, and
one or more phenolic material or composition comprising phenolic polymers or salts thereof.

2. The oil-based RDF of claim 1, further comprising at least one of:
one or more emulsifier (e.g., modified tall oil and/or modified fatty amine condensate);
one or more rheological modifier (e.g., at least one of: bentonite clay, a polyamide, a dimer diacid, or combinations thereof);
one or more alkalinity agent (e.g., lime Ca(OH));
one or more wetting agent (e.g., fatty imidazolines, soya lecithin, or combinations thereof);
the weighting or bridging agent is present in an amount of about 2.5 to about 45.0% V/V of the oil-based RDF, wherein one or more of:
at least about 50% V/V of the one or more weighting or bridging agent is acid soluble;
no more than about 10% V/V of the one or more weighting or bridging agent is acid insoluble; or
a combination thereof; or
a combination thereof.

3. The oil-based RDF of claim 2, wherein at least one of:
the acid soluble weighting or bridging agent includes or is at least one of calcium carbonate (CaCO₃), manganese oxide (Mn₃O₄), ilmenite, or a combination thereof; and
the acid insoluble weighting or bridging agent includes or is at least one of barite, insoluble components present in trimanganese tetraoxide, insoluble components present in ilmenite, insoluble components present in hematite; or a combination thereof; or
a combination thereof.

4. The oil-based RDF of claim 1, wherein at least one of:
the hygroscopic liquid is NaCl brine, NaBr brine, CaBr₂ brine, a formate brine, potassium formate, an alcohol based hygroscopic liquid, lower polyhydric alcohols, glycerol, or polyglycerol;
the oil is diesel; and
the oil-based RDF comprises about 0.25 to about 20.0 pounds per barrel (lbs/bbl) by weight of the oil-based RDF additive.

5. The oil-based RDF of claim 1, wherein at least one of:
the phenolic polymers are cross-linked; and
the hydrophobizing component or agent is an amine or amide containing compound.

6. The oil-based RDF of claim 1, wherein at least one of:
the phenolic material or composition includes at least one of: lignin, lignin derivative, and salts thereof;
the phenolic material or composition includes at least one of: organosolv lignin, milled wood lignin, cellulotic enzyme lignin, enzymatic mild acidolysis lignin, lignin extracted with ionic liquids, alkali lignin, alkali lignin slurry, sodium salt of lignin, lignin sodium salt slurry, black liquor, Kraft lignosulfonates, Kraft lignin, sulfite lignin, sulfomethylated Kraft lignin, derivatives thereof, and salts thereof;
the hydrophobizing component or agent includes at least one of a fatty amine or amidoamine, a fatty imidazoline, a fatty quaternary amine compound, a fatty imidazolinium compound, and salts thereof;
the hydrophobizing component or agent includes a fatty quaternary amine compound that includes at least one of a diamidoamine quaternary amine compound and an ester of quaternary amine compound;
the hydrophobizing component or agent includes at least one of Bis-(isostearic acid amidoethyl)-N-polyethoxy-N-methyl ammonium methosulfate, N, N-bis (tallow amidoethyl) N-polyethoxy N-methylammonium methosulfate, Di (nortallowyloxyethyl) dimethyl Ammonium Chloride, tallow amine, amidoamine, and combinations thereof; or
a combination thereof.

7. The oil-based RDF of claim 6, wherein the lignin derivative includes at least one of: a first sulfonated lignin compound having a sulfonate group located on aliphatic part of the lignin; a second sulfonated lignin compound having a sulfonate group located on aromatic part of the lignin; a third sulfonated lignin compound having a sulfonate group located on aromatic part of the lignin and another sulfonate group located on aliphatic part of the lignin; alkoxylated lignin (e.g., ethoxylated lignin or propoxylated lignin); esterified lignin (e.g., lignin esterified at the hydroxyl group, the carboxyl group, or both); hydroxypropylated lignin; phenolated lignin; alkylated lignin; urethanized lignin; hydroxyalkylated lignin; sulfomethylated lignin; nitrated lignin (e.g., a nitro group added to at least one aromatic group of the lignin); azo coupled lignin (e.g., azo group coupled to at least one aromatic group of the lignin); and a combination thereof.

8. The oil-based RDF of claim 1, wherein the blend, reaction product, or mixture thereof, further comprises formaldehyde.

9. The oil-based RDF of claim 7, wherein the blend, reaction product, or mixture thereof, includes at least one of:
the first sulfonated lignin compound that is a sulfonated Kraft lignin,
the second sulfonated lignin compound that is a sulfomethylated Kraft lignin; and
the third sulfonated lignin compound that is a Kraft lignin that has been sulfonated and sulfomethylated.

10. The oil-based RDF of claim 7, wherein the blend, reaction product, or mixture thereof, includes at least one of:
the first sulfonated lignin compound that has a degree of sulfonation between about 0.1 and about 4.0,
the second sulfonated lignin compound that has a degree of sulfonation between about 0.1 and about 4.0, and
the third sulfonated lignin compound that has a degree of sulfonation between about 0.1 and about 4.0.

11. The oil-based RDF of claim 6, wherein the fatty amine or amidoamine is prepared by reacting (e.g., reacting under heat) tall oil fatty acid with an amine (such as an ethyleneamine) having at least two (e.g., 2, 3, 4, 5, 6, 7, or more) secondary amine groups.

12. The oil-based RDF of claim 1, wherein the composition comprises at least one of:
about 5 to about 75 percent by weight of the hydrophobizing component or agent; and
about 25 to about 95 percent by weight of the phenolic material or composition.

13. The oil-based RDF of claim 1, wherein the blend, reaction product, or mixture thereof, further comprises formalin that comprises at least one of: about 30 to about 40% by weight of formaldehyde, and about 10 to about 15% by weight of methanol.

14. The oil-based RDF of claim 1, wherein the composition is a liquid (e.g., a slurry or a polyvinyl alcohol film enclosure or pod comprising a slurry) or a particulate (e.g., spray dried composition, pellets, and/or powder).

15. A method of drilling a reservoir section of a wellbore, the method comprising:
circulating an oil-based reservoir drill-in fluid (RDF) when: the drill penetrates the reservoir section, the drill is drilling the reservoir section, or both,
wherein the oil-based RDF includes (i) one or more weighting or bridging agent that includes an acid soluble weighting or bridging agent and (ii) an oil-based RDF additive comprises a blend, reaction product, or a mixture thereof, of:
one or more hydrophobizing component or agent (e.g., about 5 to about 75 percent by weight of the hydrophobizing component or agent), and
one or more phenolic material or composition comprising phenolic polymers or salts thereof (about 25 to about 95 percent by weight of the phenolic material or composition).

16. The method of claim 15, wherein the oil-based RDF comprises one or more weighting or bridging agent present in an amount of about 2.5 to about 45% V/V of the oil-based RDF, wherein one or more of:
at least about 50% of the one or more weighting or bridging agent is acid soluble;
no more than about 10% of the one or more weighting or bridging agent is acid insoluble; or
a combination thereof.

17. The method of claim 16, wherein at least one of:
the acid soluble weighting or bridging agent includes or is at least one of calcium carbonate (CaCO₃), manganese oxide (Mn₃O₄), ilmenite, or a combination thereof; and
the acid insoluble weighting or bridging agent includes or is at least one of barite, insoluble components present in trimanganese tetraoxide, insoluble components present in ilmenite, insoluble components present in hematite; or a combination thereof; or
a combination thereof.

18. The method of claim 15, wherein the oil-based RDF further comprises at least one of:
an invert emulsion of a hygroscopic liquid, and at least one of: an oil, mineral oil, synthetic oil (e.g., one or more of internal olefin, poly alpha olefin, and linear paraffin), or a combination thereof;
one or more emulsifier (e.g., modified tall oil and/or modified fatty amine condensate);
one or more rheological modifier (e.g., at least one of: bentonite clay, a polyamide, a dimer diacid, or combinations thereof);
one or more alkalinity agent (e.g., lime Ca(OH));
one or more wetting agent (e.g., fatty imidazolines, soya lecithin, or combinations thereof);
one or more corrosion inhibitor (e.g., a sulfur containing compound, an amine, or a combination thereof); or
a combination thereof.

19. The method of claim 18, wherein the oil-based RDF includes at least one of:
the hygroscopic liquid is NaCl brine, NaBr brine, CaBr₂ brine, a formate brine, potassium formate, an alcohol, lower polyhydric alcohols, glycerol, or polyglycerol;
the oil is diesel; and
the oil-based RDF comprises about 0.25 to about 20.0 pounds per barrel (lbs/bbl) by weight of the oil-based RDF additive.

20. The method of claim 15, wherein the method further comprises, after circulating the oil-based RDF, at least one of:
removing the oil-based RDF; and
removing a filter cake by treating the filter cake with a filter cake breaker fluid through the wellbore.

21. The method of claim 20, wherein the filter cake breaker fluid comprises at least one of:
a brine (e.g., a NaCl brine, NaBr brine, CaCl₂) brine, or CaBr₂ brine);
one or more acid or acid precursor (e.g., citric acid, acetic acid, esters, orthoesters (such as trimethyl orthoacetate, triethyl orthoacetate, tripropyl orthoacetate, triisopropyl orthoacetate, polyorthoacetate, trimethyl orthoformate, triethyl ortho formate, tripropyl orthoformate, triisopropyl orthoformate, polyorthoformates, trimethyl orthopropionate, and/or triethyl orthopropionate), and/or hydrochloric acid (HCl));
one or more complexing agent (e.g., a complexing agent that chelate ions of the weighting or bridging agent or agents);
one or more solvent (e.g., one or more of ethylene glycol monobutyl ether, propylene glycol monobutyl ether, methanol, isopropyl alcohol, or a combination thereof);
one or more surfactant (e.g., a one or more water wetting surfactant to make the filter cake components water wet; e.g., one or more of amine ethoxylate, cocoamido propyl betaine, fatty alcohol ethoxylates, polyoxyethylenesorbitan monolaurate 20, polyoxyethylenesorbitan monolaurate 80, or a combination thereof);
one or more pH control agent (e.g., sodium bicarbonate);
one or more corrosion inhibitor (e.g., one or more of a sulfur containing compound, a quaternary organic ammonium salt, or a combination thereof);
one or more viscosifier (e.g., hydroxyethyl cellulose); or
a combination therefore.

22. The method of claim 15, wherein the reservoir section has a permeability of about 10 millidarcy (mD) to about 2000 mD.

23. The method of claim 20, wherein removing the filter cake returns the permeability of the reservoir section to at least about 50% (e.g., at least about 55%, at least about 60%, at least about 65%, at least about 70%, at least about 75%, at least about 80%, at least about 85%, or at least about 90%) of the permeability of the reservoir section prior to drilling.

24. The method of claim 15, wherein the method further comprises, prior to circulating the oil-based RDF, at least one of:
circulating a drilling fluid through the wellbore when drilling (e.g., when drilling the well to depth, and/or not when the drill penetrates the reservoir section, the drill is drilling the reservoir section or both); and
removing the drilling fluid from the wellbore.

25. The method of claim 24, wherein the drilling fluid comprises: an invert emulsion of a hygroscopic liquid (e.g., a brine, such as CaCl₂) brine), an oil (e.g. diesel), mineral oil, and internal olefin.

26. The method of claim 15, wherein at least one of:
the phenolic polymers are cross-linked; and
the hydrophobizing component or agent is an amine or amide containing compound.

27. The method of claim 15, wherein at least one of:
the phenolic material or composition includes at least one of: lignin, lignin derivative, and salts thereof;
the phenolic material or composition includes at least one of: organosolv lignin, milled wood lignin, cellulotic enzyme lignin, enzymatic mild acidolysis lignin, lignin extracted with ionic liquids, alkali lignin, alkali lignin slurry, sodium salt of lignin, lignin sodium salt slurry, black liquor, Kraft lignosulfonates, Kraft lignin, sulfite lignin, sulfomethylated Kraft lignin, derivatives thereof, and salts thereof;
the hydrophobizing component or agent includes at least one of a fatty amine or amidoamine, a fatty imidazoline, a fatty quaternary amine compound, a fatty imidazolinium compound, and salts thereof;
the hydrophobizing component or agent includes a fatty quaternary amine compound that includes at least one of a diamidoamine quaternary amine compound and an ester of quaternary amine compound;
the hydrophobizing component or agent includes at least one of Bis-(isostearic acid amidoethyl)-N-polyethoxy-N-methyl ammonium methosulfate, N, N-bis (tallow amidoethyl) N-polyethoxy N-methylammonium methosulfate, Di (nortallowyloxyethyl) dimethyl Ammonium Chloride, tallow amine, amidoamine, and combinations thereof; or
a combination thereof.

28. The method of claim 15, wherein the lignin derivative includes at least one of: a first sulfonated lignin compound having a sulfonate group located on aliphatic part of the lignin; a second sulfonated lignin compound having a sulfonate group located on aromatic part of the lignin; a third sulfonated lignin compound having a sulfonate group located on aromatic part of the lignin and another sulfonate group located on aliphatic part of the lignin; alkoxylated lignin (e.g., ethoxylated lignin or propoxylated lignin); esterified lignin (e.g., lignin esterified at the hydroxyl group, the carboxyl group, or both); hydroxypropylated lignin; phenolated lignin; alkylated lignin; urethanized lignin; hydroxyalkylated lignin; sulfomethylated lignin; nitrated lignin (e.g., a nitro group added to at least one aromatic group of the lignin); azo coupled lignin (e.g., azo group coupled to at least one aromatic group of the lignin); and a combination thereof.

31. The method of claim 15, wherein the blend, reaction product, or mixture thereof, further comprises formaldehyde.
